(19) United States
(12) Patent Application Publication
(10) Pub. No.: US 2014/0328997 A1
(43) Pub. Date: Nov. 6, 2014

(54) Production of Enriched Products

(71) Applicants: Ilya Raskin, Manalapan, NJ (US); Rocky Graziose, Huntington, NY (US)

(72) Inventors: Ilya Raskin, Manalapan, NJ (US); Rocky Graziose, Huntington, NY (US)

(73) Assignee: RUTGERS, THE STATE UNIVERSITY OF NEW JERSEY, New Brunswick, NJ (US)

(21) Appl. No.: 14/343,747

(22) PCT Filed: Sep. 7, 2012
(86) PCT No.: PCT/US12/54096

§ 371 Date: Jul. 7, 2014

Related U.S. Application Data
(60) Provisional application No. 61/532,458, filed on Sep. 8, 2011.

(51) Int. Cl. A23L 1/30; A23J 3/08; A23J 1/20

(52) U.S. Cl. CPC A23L 1/3002; A23J 1/20; A23J 3/08; A23V 2002/00
USPC 426/657

(57) ABSTRACT

Methods for the production of enriched plant polyphenols-dairy (e.g., milk) or polyphenols-ground edible material products that can be used in the preparation of functional foods, dietary supplements, medical foods, cosmetic products or pharmaceutical agents. The method of obtaining a polyphenol-dairy protein product comprising the steps of (a) combining a plant-derived polyphenol and a dairy product such as a dairy product comprising a protein, to form the polyphenol-dairy protein (e g, milk protein) product and a liquor; and (b) separating the polyphenol-dairy protein product from the liquor. In various embodiments, the plant-derived polyphenols and dairy product are a mixture of solid products, such as would be found in a dry composition. These methods also provide for the immobilization of these component(s) on the healthy, nutritious, and low-sugar food matrix provided by the ground edible material.

### CROSS-REFERENCE TO RELATED APPLICATION

The present application claims the benefit of priority to U.S. Provisional Application No. 61/532,458, filed Sep. 8, 2011, the disclosure of which is hereby incorporated by reference in its entirety.

### FIELD OF THE INVENTION

The present invention is directed to methods for the production of an enriched product, for example an enriched plant polyphenol-dairy (e.g., milk) product, and compositions produced therefrom.

### BACKGROUND OF THE INVENTION

It is known that many foods contain numerous health/wellness-promoting and disease-preventing/curing compounds (Schmidt et al., Nat. Chem. Biol., 3:360-366, 2007; Raskin et al., Curr. Pharm. Design, 10:3419-3429, 2004). Plants are a particularly rich source of such compounds. Unfortunately, the co-evolution of people and edible plants and the advance of modern agriculture have favored the reduction of beneficial, bioactive products in plant foods (Schmidt et al., Met. Clin. Exp., 57:S3-S9, 2008). Extensive plant breeding and selection has reduced the content of healthy ingredients, such as various antioxidants, polyphenols, bioflavonoids, glucosinolates, healthy fibers, fatty acids, vitamins, and minerals in most plant foods. This reduction was caused by the need to maximize the caloric content, palatability, and digestibility of plant foods by directing plant metabolism to accumulating starches, sugars, oils, and/or major proteins in edible parts at the expense of losing bioactive secondary metabolites. As a result, many health-promoting and disease-fighting products and bioactives were reduced to levels where average daily consumption cannot produce measurable health benefits. To supply a beneficial amount of plant-derived bioactives, food plants are then extracted with solvents and sold in oral form as concentrated supplements

One approach to concentrating bioactives is use of ion-exchange chromatography, which can be used for concentrating and isolating a great variety of compounds. It is based on specific electrostatic interactions between charges on the surface of compounds in a mobile fluid phase and solid ion exchangers (resins). As a result, some compounds bind to the ion exchange matrix, while others remain in the solution. Ion-exchangers and compounds should be in the same polarity range to effectively bind to each other. However, ion-exchange chromatography is very expensive because it uses synthetic resins and organic solvents to elute bound phytochemicals from resins. In addition to high cost, this method is often not allowed in food manufacturing and cannot be called “natural” or “organic.”

### SUMMARY OF THE INVENTION

The disclosure provides improved methods for the production of enriched products comprising a dairy product such as a dairy (e.g., milk) product, plant polyphenol and/or ground edible material. This discovery enables a one-step concentration and separation of these component(s) from the sugars, fats, oils and other components of conventional plant extracts or dairy (e.g., milk) dairy products such as dairy (e.g., milk) products. These methods also provide for the immobilization of these component(s) on the healthy, nutritious, and low-sugar food matrix provided by the ground edible material.

One aspect the disclosure provides a method of obtaining a polyphenol-dairy (e.g., milk) protein product comprising the steps of (a) combining a plant-derived polyphenol and a dairy product such as a dairy (e.g., milk) product comprising a protein, e.g., a dairy (e.g., milk) protein, to form the polyphenol-dairy protein (e.g., milk protein) product and a liquor; and (b) separating the polyphenol-dairy protein (e.g., milk protein) product from the liquor. In various embodiments, the plant-derived polyphenols and dairy (e.g., milk) product are a mixture of solid products, such as would be found in a dry composition. In some embodiments, the dairy (e.g., milk) product is a solid.

In various embodiments, the separating is performed by a process selected from the group consisting of filtration, centrifugation and natural-density separation.

In some embodiments, the method further comprises reducing the pH. In various embodiments, the pH is reduced by addition of an acid selected from the group consisting of acetic acid, adipic acid, citric acid, fumaric acid, glucono-delta-lactone, hydrochloric acid, lactic acid, malic acid, phosphoric acid, succinic acid and tartaric acid.

In further embodiments, the pH is reduced by adding to the composition a substance selected from the group consisting of lactic acid bacteria and yeast.

In some embodiments, the pH is reduced to about 4.0.

In still further embodiments, methods are provided wherein the combining of a dairy product with a plant-derived polyphenol further comprises adding rennet.

In further embodiments, the dairy (e.g., milk) is selected from the group consisting of dry dairy (e.g., milk), evaporated dairy (e.g., milk), whole dairy (e.g., milk), low fat dairy (e.g., milk), 2% dairy (e.g., milk), 1% dairy (e.g., milk), heavy cream and a mixture thereof. In still further embodiments, the dairy (e.g., milk) is a solution comprising a dairy (e.g., milk) protein, and in various aspects the dairy (e.g., milk) protein is selected from the group consisting of casein, whey and a mixture thereof.

The disclosure also provides, in various embodiments, methods wherein a plant juice is the source of the plant-derived polyphenol. In various embodiments, the plant juice is the juice of a blueberry, blackberry, raspberry, hockenberry, gooseberry, boysenberry, acai berry, baneberry, barberry, bearberry, bilberry, chokeberry, bunchberry, buffalo berry, chokecherry, cowberry, elderberry, cranberry, dew berry, currant, farkleberry, goji berry, gooseberry, grape, holly berry, huckleberry, ivy berry, june berry, juniper berry, lingonberry, logan berry, mistletoe berry, nannyberry, Oregon grape, persimmon, pokeberry, privet berry, salmonberry, strawberry, sugarberry, tayberry, thimbleberry, white mulberry, red mulberry, black mulberry, wineberry, wintergreen, yew berry, or young berry. In specific aspects, it is contemplated that the plant juice is selected from the group consisting of blueberry juice and cranberry juice.

Some embodiments of the method of obtaining a polyphenol-dairy (e.g., milk) protein product further comprise use of a ground edible material. In some embodiments, the ground edible material is an edible plant material that has been milled, for example by grinding or pulverizing, to produce a plant flour. In further embodiments, the ground edible material comprises a protein that associates with a plant-derived polyphenol.

The disclosure also provides a method of obtaining an edible material-dairy (e.g., milk) protein product comprising the steps of (a) combining a ground edible material and a dairy (e.g., milk) product comprising a dairy (e.g., milk) protein to form an edible material-dairy (e.g., milk) protein product and a liquor; and (b) separating the dairy (e.g., milk) protein product from the liquor. In various embodiments, the combined ground edible material and dairy (e.g., milk) product is a mixture of solid products, such as would be found in a dry composition. In some embodiments, the dairy (e.g., milk) product is a solid. In further embodiments, methods are provided wherein the combining of a dairy product with a ground edible material further comprises adding rennet.

In a related aspect, the method of obtaining an edible material-dairy (e.g., milk) protein product comprises the steps enumerated in the preceding paragraph and further comprises reducing the pH. In some embodiments, the pH is reduced to about 4.0.

In some embodiments of each of the methods disclosed herein, the pH is reduced. An exemplary pH reduction is achieved by addition of an acid selected from the group consisting of acetic acid, adipic acid, citric acid, fumaric acid, glucono-delta-lactone, hydrochloric acid, lactic acid, malic acid, phosphoric acid, succinic acid and tartaric acid.

In some embodiments, the pH is reduced by adding a substance selected from the group consisting of lactic acid bacteria and yeast.

In some embodiments of each of the methods disclosed herein, the dairy (e.g., milk) product is selected from the group consisting of dry dairy (e.g., milk), condensed dairy (e.g., milk), whole dairy (e.g., milk), low fat dairy (e.g., milk), 2% dairy (e.g., milk), 1% dairy (e.g., milk), heavy cream and mixtures thereof. Exemplary dairy (e.g., milk) products include a dairy (e.g., milk) product, or dairy (e.g., milk), comprising a dairy (e.g., milk) protein, such as but not limited to a dairy (e.g., milk) protein selected from the group consisting of casein, whey and a mixture thereof.

The disclosure also provides a method of obtaining a plant-derived polyphenol-protein product comprising the steps of (a) combining a composition comprising a plant-derived polyphenol and a ground edible material to form the polyphenol-protein product and a liquor; and (b) separating the plant-derived polyphenol-protein product from the liquor. In this aspect of the disclosure, it is contemplated that the ground edible material comprises a protein that associates with the plant-derived polyphenol. In some embodiments, the method further comprises the step of reducing the pH.

Thus, in various embodiments the pH is reduced by addition of an acid selected from the group consisting of acetic acid, adipic acid, citric acid, fumaric acid, glucono-delta-lactone, hydrochloric acid, lactic acid, malic acid, phosphoric acid, succinic acid and tartaric acid. In some embodiments, the pH is reduced by adding a substance selected from the group consisting of lactic acid bacteria and yeast. In various embodiments, the pH is reduced to about 4.0.

Methods according to the disclosure include embodiments wherein a plant juice is the source of the plant-derived polyphenol. Accordingly, in various embodiments the plant juice is the juice of a blueberry, blackberry, raspberry, hockenberry, gooseberry, boysenberry, acai berry, baneberry, barberry, bearberry, bilberry, chokeberry, bunchberry, buffalo berry, chokecherry, cowberry, elderberry, cranberry, dew berry, currant, farkleberry, goji berry, gooseberry, grape, holly berry, huckleberry, ivy berry, june berry, juniper berry, lingonberry, logan berry, mistletoe berry, nannyberry, Oregon grape, persimmon, pokeberry, privet berry, salmonberry, strawberry, sugarberry, tayberry, thimbleberry, white mulberry, red mulberry, black mulberry, wineberry, wintergreen, yew berry, or young berry. In some embodiments, the plant juice is selected from the group consisting of blueberry juice and cranberry juice.

The disclosure also provides compositions comprising the product of any of the methods disclosed herein.

In any of the ranges described herein, the endpoints of the range are included in the range. Additional features and variations of the disclosure will be apparent to those skilled in the art from the entirety of this application and all such features are intended as aspects of the disclosure. Likewise, features of the disclosure described herein can be re-combined into additional embodiments that also are intended as aspects of the disclosure, irrespective of whether the combination of features is specifically mentioned above as an aspect or embodiment of the disclosure. Also, only such limitations as are described herein to be critical to the disclosure should be viewed as such; variations of the invention lacking limitations which have not been described herein as critical are intended as aspects of the disclosure.

The invention is also described by the following exemplary embodiments, provided in the numbered paragraphs below:

1. A method of obtaining a polyphenol-milk protein product comprising the steps of:

(a) combining a composition comprising a plant-derived polyphenol and a milk product comprising a milk protein to form the polyphenol-milk protein product and a liquor; and

(b) separating the polyphenol-milk protein product from the liquor.

2. The method of paragraph 1 further comprising the step of reducing the pH.

3. The method of paragraph 2, wherein the pH is reduced by addition of an acid selected from the group consisting of acetic acid, adipic acid, citric acid, fumaric acid, glucono-delta-lactone, hydrochloric acid, lactic acid, malic acid, phosphoric acid, succinic acid and tartaric acid.

4. The method of paragraph 2, wherein the pH is reduced by adding to the composition a substance selected from the group consisting of lactic acid bacteria and yeast.

5. The method of any one of paragraphs 2-4, wherein the pH is reduced to about 4.0.

6. The method of any one of paragraphs 1-5 further comprising the step of adding rennet.

7. The method of any one of paragraphs 1-6, wherein the composition is a dry composition.

8. The method of any one of paragraphs 1-7, wherein the milk is selected from the group consisting of dry milk, evaporated milk, whole milk, low fat milk, 2% milk, 1% milk, heavy cream and a mixture thereof.

9. The method of any one of paragraphs 1-7, wherein the milk is a solution comprising a milk protein.

10. The method of paragraph 9, wherein the milk protein is selected from the group consisting of casein, whey and a mixture thereof.

11. The method of any one of paragraphs 1-10, wherein a plant juice supplies the plant-derived polyphenol.

12. The method of paragraph 11, wherein the plant juice is the juice of a blueberry, blackberry, raspberry, hockenberry, gooseberry, boysenberry, acai berry, baneberry, barberry, bearberry, bilberry, chokeberry, bunchberry, buffalo berry, chokecherry, cowberry, elderberry, cranberry, dew berry, currant, farkleberry, goji berry, gooseberry, grape, holly berry, huckleberry, ivy berry, june berry, juniper berry, lingonberry, logan berry, mistletoe berry, nannyberry, Oregon grape, persimmon, pokeberry, privet berry, salmonberry, strawberry, sugarberry, tayberry, thimbleberry, white mulberry, red mulberry, black mulberry, wineberry, wintergreen, yew berry, or young berry.

13. The method of paragraph 11, wherein the plant juice is selected from the group consisting of blueberry juice and cranberry juice.

14. The method of any one of paragraphs 1-13 further comprising a ground edible material.

15. The method of paragraph 14, wherein the ground edible material is a plant flour.

16. The method of any one of paragraphs 1-15, wherein the separating is performed by a process selected from the group consisting of filtration, centrifugation and natural density separation.

17. A method of obtaining an edible material-milk protein product comprising the steps of:

(a) combining a composition comprising a ground edible material and milk to form the edible material-milk protein product and a liquor; and

(b) separating the edible material-milk protein product from the liquor.

18. The method of paragraph 17 further comprising the step of reducing the pH.

19. The method of paragraph 18, wherein the pH is reduced by addition of an acid selected from the group consisting of acetic acid, adipic acid, citric acid, fumaric acid, glucono-delta-lactone, hydrochloric acid, lactic acid, malic acid, phosphoric acid, succinic acid and tartaric acid.

20. The method of paragraph 19, wherein the pH is reduced by adding to the composition a substance selected from the group consisting of lactic acid bacteria and yeast

21. The method of any one of paragraphs 18-20, wherein the pH is reduced to about 4.0.

22. The method of any one of paragraphs 17-21 further comprising the step of adding rennet.

23. The method of any one of paragraphs 17-22, wherein the composition is a dry composition.

24. The method of any one of paragraphs 17-23, wherein the milk is selected from the group consisting of dry milk, condensed milk, whole milk, low fat milk, 2% milk, 1% milk, heavy cream and mixtures thereof.

25. The method of any one of paragraphs 17-23, wherein the milk is a solution comprising a milk protein.

26. The method of paragraph 25, wherein the milk protein is selected from the group consisting of casein, whey and a mixture thereof.

27. The method of any one of paragraphs 17-26, wherein the ground edible material is plant flour.

28. A method of obtaining a polyphenol-protein product comprising the steps of:

(a) combining a composition comprising a plant-derived polyphenol and a ground edible material to form the polyphenol-protein product and a liquor; and

(b) separating the polyphenol-protein product from the liquor.

29. The method of paragraph 28 further comprising the step of reducing the pH.

30. The method of paragraph 29, wherein the pH is reduced by addition of an acid selected from the group consisting of acetic acid, adipic acid, citric acid, fumaric acid, glucono-delta-lactone, hydrochloric acid, lactic acid, malic acid, phosphoric acid, succinic acid and tartaric acid.

31. The method of any one of paragraphs 29-30, wherein the pH is reduced to about 4.0.

32. The method of any one of paragraphs 28-31, wherein the ground edible material is plant flour.

33. The method of any one of paragraphs 28-32, wherein a plant juice supplies the plant-derived polyphenol.

34. The method of paragraph 33, wherein the plant juice is the juice of a blueberry, blackberry, raspberry, hockenberry, gooseberry, boysenberry, acai berry, baneberry, barberry, bearberry, bilberry, chokeberry, bunchberry, buffalo berry, chokecherry, cowberry, elderberry, cranberry, dew berry, currant, farkleberry, goji berry, gooseberry, grape, holly berry, huckleberry, ivy berry, june berry, juniper berry, lingonberry, logan berry, mistletoe berry, nannyberry, Oregon grape, persimmon, pokeberry, privet berry, salmonberry, strawberry, sugarberry, tayberry, thimbleberry, white mulberry, red mulberry, black mulberry, wineberry, wintergreen, yew berry, or young berry.

35. The method of paragraph 34, wherein the plant juice is selected from the group consisting of blueberry juice and cranberry juice.

36. A composition comprising the product of any one of paragraphs 1, 17 and 28.

### DETAILED DESCRIPTION OF THE INVENTION

### Definitions

The terms “polyphenol-dairy (e.g., milk) protein product” or “edible material-dairy (e.g., milk) protein product” or “polyphenol-protein product” as used herein means a product produced by a method disclosed herein that comprises a compound present in plant juice associated (e.g., by absorption or adsorption) with a dairy (e.g., milk) protein or ground edible material. The polyphenol-protein product is intended to improve the general health or wellness of an animal such as a mammal and/or to provide a nutritional or therapeutic benefit to the animal when consumed. The term “product” is used herein to mean a result of the association of a protein (from a dairy (e.g., milk) source and/or a ground edible material source) and a plant-derived polyphenol. Thus, the products of the disclosure comprise a compound present in plant juice or dairy (e.g., milk) product that becomes associated (e.g., by absorption or adsorption) with another material, for example and without limitation, a ground edible material, that is intended to improve the general health or wellness of an animal such as a mammal and/or that provides a nutritional or therapeutic benefit to the animal when consumed. Exemplary products include, but are not limited to, proteins, stiviol glucosides, and phytochemicals such as polyphenols, anthocyanins/proanthocyanidins, bioflavonoids, carotenoids, catechins, glucosinolates, organosulphides, gingerols and phytoestrogens.

A “product” as disclosed herein is a molecular complex comprising one or more sorbed plant juice or dairy (e.g., milk) product “components.” A component as used herein refers to a compound present in a plant juice or dairy (e.g., milk) product for which enrichment or concentration is desired. One exemplary component of plant juice is a polyphenol.

An “alternative product” as used herein comprises a compound present in plant juice or dairy (e.g., milk) product that is intended to taste good, improve the palatability of food with which it is associated, color a food product, or color non-food substances (e.g., textiles, plastics, paints and finishes), but may not provide a therapeutic benefit to a mammal when consumed other than providing an energy source. Accordingly, an alternative product lacks plant juice or dairy (e.g., milk) product component(s) as defined herein. In rare circumstances it would be apparent to one of skill from the disorder, disease or condition of an animal ingesting an alternative product, that an alternative product may be therapeutic in providing, e.g., a fat or oil to treat a lipid disorder, disease or condition or sugars to treat a hypoglycemic disorder, disease or condition. The alternative product comprises, in some embodiments, any compound present in the plant juice (or dairy (e.g., milk) product) that is not part of a product as defined herein. In some embodiments, the alternative product is selected from the group consisting of soluble carbohydrates, fats and oils. In some embodiments, the alternative product is a soluble carbohydrate. In some embodiments, the soluble carbohydrate is a sugar selected from the group consisting of fructose, glucose, sucrose, galactose, raffinose, stachyose, maltose and lactose.

The term “plant juice” refers to plant material that has been homogenized, extracted, squeezed or juiced from a plant or plant part. “Plant juice” also refers to plant material that is made into teas, infusions, tinctures, suspensions, emulsions and combinations thereof that are made from plant material. In one embodiment, the plant juice may be prepared by drawing out, withdrawing, distilling or otherwise separating one substance from another by a chemical or physical process. The plant material will typically be fragmented by slicing, pulverizing, grinding or by any other technique known in the art to increase surface area and thereby facilitate exposure to a fluid such as a solvent (e.g., water or alcohol) in preparation of a plant juice. Plant juice is understood to comprise phenolic compounds (e.g., polyphenols, anthocyanins, and proanthocyanidins or hydrolyzable tannins).

The term “ground edible material” as used herein refers to any edible solid material that has been processed to increase its surface area, such as by grinding or milling by methods known in the art. In some embodiments, the ground edible material is derived from a plant or microbe that has been processed to increase its surface area, such as by shearing, grinding, pulverizing or milling, using any method known in the art. Grinding, milling, or pulverizing plant material is preferred because it greatly increases the surface area of the edible material. In some embodiments, the ground edible material is a plant flour. The use of other ground edible materials such as soybean protein concentrate, soybean protein isolate, protein powder (including, but not limited to, egg powder, gluten and yeast powder) and cellulose- or chitin-containing material (including, but not limited to, non-soluble vegetable fibers) is also contemplated. In other embodiments, the ground edible material is a bran, produced from the outer layer of plant seeds. Bran includes, but is not limited to, wheat bran, corn bran, rice bran, oat bran and barley bran.

The term “dairy product” as used herein refers to dairy (e.g., milk) or a dairy (e.g., milk) protein solution ultimately derived from a mammal such as a cow, goat, sheep, buffalo, yak, ox, pig, camel, and llama. Dairy (e.g., milk) useful in the practice of the methods includes but is not limited to dry dairy (e.g., milk), evaporated dairy (e.g., milk), whole dairy (e.g., milk), low fat dairy (e.g., milk), 2% dairy (e.g., milk), 1% dairy (e.g., milk), heavy cream and a mixture thereof. Casein, whey and a mixture thereof can also be used as the dairy (e.g., milk) product in the methods described herein.

A “dairy product” refers to a dairy (e.g., milk) product, a form of dairy (e.g., milk), as well as to a product produced from a dairy (e.g., milk). The definition of a dairy product includes a dairy (e.g., milk) product as well as crème fraîche, clotted cream, smetana, sour cream, cultured butterdairy (e.g., milk), kefir, kumis/airag, powdered dairy (e.g., milk), whey products, ice cream, condensed dairy (e.g., milk), khava, evaporated dairy (e.g., milk), Ricotta cheese or khoa, infant formula, baked dairy (e.g., milk), boiled dairy (e.g., milk), butter, butterdairy (e.g., milk), clarified butter or ghee, smen, anhydrous dairy (e.g., milk) fat, cheese, curds, paneer, whey, cottage cheese, quark, cream cheese, fromage frais, casein, caseinates, dairy (e.g., milk) protein concentrates and isolates, whey protein concentrates and isolates, dairy (e.g., milk) hydrolysates, yogurt, ayran, lassi, clabber, gelato, ice cream, ice dairy (e.g., milk), frozen custard, frozen yogurt, viili, kajmak, filmjolk, piima, vla, dulce de leche, and skyr.

The term “liquor” as used herein refers to the liquid remaining after a plant juice has been in contact with a dairy (e.g., milk) product and any resulting solids removed (the enriched product has been removed), or the liquid remaining after a plant juice has been in contact with a ground edible material and any resulting solids removed (the enriched product has been removed), or the liquid remaining after the ground edible material has been in contact with the dairy (e.g., milk) product and any resulting solids removed (the enriched product has been removed). The liquor retains the non-products from the plant juice or dairy (e.g., milk) product, separate or appreciably separate from the product. For example and without limitation, when the composition comprises plant juice and a ground edible material, the liquor (or plant liquor) retains the non-products from the plant juice whereas the ground edible material retains at least one product of the plant juice.

The term “plant” refers to whole plants and plant parts and, as used herein, refers to higher, or vascular, plants (gymnosperms and angiosperms, including plants providing fruits and vegetables, as well as medicinal plants), lower, or non-vascular, plants (e.g., algae and fungi), and unicellular yeast. Exemplary plant parts (with respect to vascular plants) include, but are not limited to, bark, a flower (or petal thereof), a tuber, a stem or shoot, a root, a fruit, a berry, a seed, a nut and a leaf of a plant.

The term “extract” may be a single extract obtained from a particular extraction step or series of extraction steps or the extract may be a combination of extracts obtained from separate extraction steps. Such combined extracts are thus also encompassed by the term “extract.” Solvents for use in extraction methods include water and well-known organic solvents such as, but not limited to, alcohols, alkanes, halocarbons, ethers, aromatic solvents, ketones, aqueous solvents, esters, and supercritical fluids. In one embodiment, ethanol is used to prepare a plant extract that yields a plant juice according to the disclosure. Like water, a benefit of incorporating an ethanolic solvent in the final extraction step is that an ethanolic solvent is compatible with an ingestible product, and therefore is suitable for incorporation into a pill, capsule, tablet, and other ingestible forms known in the art.

As used herein, the term “sorb” refers to adsorb, absorb, or a combination thereof. Analogously, the term “sorption” refers to adsorption, absorption, or a combination thereof. “Sorption” is given the meaning it has acquired in the art, i.e., the taking up and holding of one substance by another, which includes the processes of adsorption and/or absorption. The term “adsorption,” is given its ordinary meaning in referring to the physical adherence or association of one substance (e.g., a component present in a plant juice or a dairy (e.g., milk) product that becomes associated with another material) to the surface of another substance (e.g., a ground edible material). Also given its ordinary meaning in the art, “absorption” refers to the taking up or incorporation of one substance (e.g., a component present in a plant juice or dairy (e.g., milk) product that becomes associated with another material) into another substance (e.g., a ground edible material). The term “desorption” refers to the converse process in which a substance (e.g., a component present in a plant juice or dairy (e.g., milk) product that becomes associated with another material) is released from another substance (e.g., a ground edible material).

The term “admixture” as used herein refers to a composition produced by mixing or commingling compounds of the disclosure (for example and without limitation, mixing a plant-derived polyphenol and a dairy (e.g., milk) product comprising a dairy (e.g., milk) protein to form a polyphenol-dairy (e.g., milk) dairy protein product and a liquor).

### Methods of Obtaining a Product

The present disclosure is based on the discovery that co-precipitation of a dairy product, such as a milk product, and a component of a plant juice such as a plant polyphenol is facilitated by reducing the pH of a composition comprising the dairy product and the component of the plant juice, e.g., the plant polyphenol. Dairy (e.g., milk) product and/or ground edible material effectively binds and retains components obtainable from plant material (e.g., by homogenization, extraction, squeezing or juicing), and co-precipitation of a dairy (e.g., milk) product and a ground edible material, or a plant juice and ground edible material, is facilitated by reducing the pH of the composition. The products obtainable from plant material may be obtained as an extract, an exudate, a suspension, an emulsion, a secretion, a tea or a tincture, collectively referred to herein as a “plant juice.”

As exemplified herein, reducing the pH of a composition of the disclosure has been found to increase the co-precipitation of plant-derived polyphenols and dairy (e.g., milk) product and/or ground edible material, or co-precipitation of dairy (e.g., milk) product and ground edible material. In some embodiments of the methods of the disclosure, the increase in co-precipitation of plant-derived polyphenols and dairy (e.g., milk) product and/or ground edible material, or co-precipitation of dairy (e.g., milk) product and ground edible material, is at least about 1% by weight relative to the co-precipitation in the absence of the reduction in pH. In various aspects, the increase in co-precipitation of plant-derived polyphenols and dairy (e.g., milk) product and/or ground edible material, or co-precipitation of dairy (e.g., milk) product and ground edible material, is, by weight, at least about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or at least about 2-fold, about 3-fold, about 4-fold, about 5-fold, about 10-fold, about 20-fold, about 50-fold, about 100-fold or more relative to the co-precipitation in the absence of the reduction in pH.

It is contemplated that the pH of a composition is reduced by any method known to those of skill in the art. In various embodiments of the methods of obtaining products, the pH is reduced by addition of an acid selected from the group consisting of acetic acid, adipic acid, citric acid, fumaric acid, glucono-delta-lactone, hydrochloric acid, lactic acid, malic acid, phosphoric acid, succinic acid and tartaric acid. In further aspects, the pH is reduced by adding to the composition a substance selected from the group consisting of lactic acid bacteria, yeast and a combination thereof.

Irrespective of the method used to reduce the pH of the composition, the present disclosure contemplates that, in some embodiments, the pH is reduced to about 4.0. In another aspect, the pH is reduced to about 2.0. In various embodiments, the pH is reduced to about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, about 5.0 or about 6.0.

In further embodiments, the pH of the composition is reduced to between pH 2.0 to 5.0, or between 2.5 to 4.5, or between 3 to 4.5, or between 3.5 to 4.5, or between 3.5 to 4.0.

Reduction in pH is also described as a reduction relative to a starting pH. In one non-limiting example, subsequent to combining a composition comprising a plant-derived polyphenol and a dairy (e.g., milk) product, the pH is 6.0. In embodiments wherein the desired final pH is 4.0, the pH is thus reduced by 2.0 pH units. Accordingly, also contemplated herein are methods in which the pH is reduced by about 12, about 11.5, about 11, about 10.5, about 10, about 9.5, about 9, about 8.5, about 8, about 7.5, about 7, about 6.5, about 6, about 5.5, about 5, about 4.5, about 4, about 3.5, about 3, about 2.5, about 2, about 1.5, about 1, or about 0.5 pH units.

In further embodiments, the pH of the composition is reduced after the combining step of any of the methods described herein. In other embodiments, the pH is reduced before the combining step of any of the methods described herein. Thus, in one non-limiting example, the pH of a composition comprising a plant-derived polyphenol is reduced to pH 4.0 prior to the addition of a dairy (e.g., milk) product. Alternatively, in some embodiments a composition comprising a dairy (e.g., milk) product is reduced to pH 4.0 prior to the addition of a plant-derived polyphenol. In aspects wherein the pH is reduced before the combining step, it is further contemplated that, in some embodiments, a further reduction in pH is required to achieve a desired final pH.

Alternatively or in addition, in any of the methods disclosed herein, co-precipitation of a dairy (e.g., milk) product and a ground edible material, or a dairy (e.g., milk) product and plant juice, is facilitated by the addition of one or more enzymes or enzyme complexes. One exemplary enzymatic complex useful in facilitating co-precipitation is rennet.

It is desirable, in some embodiments, to produce a plant liquor comprising a non-product present in the plant juice that does not sorb (or sorbs weakly) to the ground edible material. For example, in another aspect, the disclosure provides a method of producing a plant liquor from plant juice comprising combining the plant juice with a ground edible material to form an admixture containing a product comprising a component from the plant juice and a plant liquor comprising an alternative product from the plant juice; thereby producing a plant liquor from the plant juice.

In some embodiments, the amount of dairy (e.g., milk) product or ground edible material that is in contact with the plant juice may be insufficient to achieve quantitative sorption of a component, or the flow rate of the plant juice over the dairy (e.g., milk) product and/or ground edible material may be incompatible with quantitative sorption, resulting in less than 100% of the component(s) (as defined herein) present in the plant juice being sorbed to the dairy (e.g., milk) product and/or ground edible material. For example, once the dairy (e.g., milk) product and/or ground edible material has reached the point of saturation, component(s), which under optimal conditions would have sorbed to the dairy (e.g., milk) product and/or ground edible material, remain in solution in the liquor. Such component(s) could be separated from the liquor using techniques well known in the art and described elsewhere herein. In one embodiment, the liquor is contacted with a dairy (e.g., milk) product and/or ground edible material as described herein to sorb any residual component(s) present in the liquor to the dairy (e.g., milk) product and/or ground edible material.

In some embodiments, at least 40% of the component(s) present in the plant juice are sorbed to the dairy (e.g., milk) product and/or ground edible material. In other embodiments, at least 45%, at least 50%, at least 55%, at least 60%, at least 65%, at least 70%, at least 75%, at least 80%, at least 85%, at least 90%, at least 95%, at least 99% or at least 99.5% of the component(s) present in the plant juice are sorbed to the dairy (e.g., milk) product and/or ground edible material. Similarly, in some embodiments, less than 40% of the component(s) are present in the liquor. In other embodiments, less than 35%, less than 30%, less than 25%, less than 20%, less than 15%, less than 10%, less than 5% or less than 1% of the component(s) are present in the liquor.

In some embodiments, less than 5% of the alternative products (e.g., soluble carbohydrates) present in the plant juice are sorbed to the dairy (e.g., milk) product and/or ground edible material. In other embodiments, less than 20%, less than 10%, less than 5%, less than 4%, less than 3%, less than 2% or less than 1% of the alternative products (e.g., soluble carbohydrates) present in the plant juice are sorbed to the dairy (e.g., milk) product and/or ground edible material.

With respect to adsorption, and without wishing to be bound to any particular theory, the adsorption of the plant juice component(s) to the dairy (e.g., milk) product and/or ground edible material appears to be based on the ion exchange properties and large surface area of the dairy (e.g., milk) product constituents and/or ground edible material that enable the material to bind to moderately charged products obtainable from plant juice, while highly charged, non-products such as polar carbohydrates and sugars and poorly charged, non-polar fats and oils remain in solution in the plant juice. The dairy (e.g., milk) product and/or ground edible material has a propensity to adsorb component(s) of intermediate polarity. Relatively hydrophobic (non-polar), oil-soluble compounds such as carotenoids and polar, highly water-soluble sugars are poorly adsorbed. This property allows for efficient, low-cost concentration of component(s) obtained from a plant juice in a food matrix provided by the dairy (e.g., milk) product and/or ground edible material described herein. This property also allows for efficient separation of non-products from plant juice for use as pleasant-tasting food additives (e.g., natural sweeteners), flavorings or colorings.

As described herein, the ground edible material generally does not sorb highly hydrophobic or highly hydrophilic products (e.g., calorie-rich sugars, oils or fats) associated with most commercial fruit juices. This enables a one-step concentration and separation of component(s) from the sugars, fats, oils, and other constituents of conventional plant extracts. This also enables the separation of non-products from the component(s) present in most fruit juices. In some embodiments, these methods also provide for the immobilization of the component(s) within the healthy, nutritious, and low-sugar food matrix provided by ground edible plant material and, in some aspects, a dairy (e.g., milk) product. The methods described herein also provide for the separation of non-products such as soluble carbohydrates (e.g., sugars), oils and fats associated with plant juice for use as natural food additives, such as sweeteners, flavorings (flavors) or colorings (colors or natural pigments).

### Methods of Obtaining Alternative Products

It is desirable, in some embodiments, to produce a plant liquor comprising alternative products present in the plant juice that do not detectably sorb to the ground edible material. For example, in another aspect, the disclosure provides a method of producing a plant liquor from plant juice comprising combining the plant juice with a ground edible material to form an admixture containing a product comprising a component from the plant juice and a plant liquor comprising an alternative product from the plant juice; thereby producing a plant liquor from the plant juice.

It will be understood that, because an alternative product is obtained during the method for obtaining a product, the methods for obtaining the alternative product will follow the steps for obtaining a product, as outlined herein above. Subsequent isolation of the alternative product is carried out using standard techniques known to those of ordinary skill in the art.

### Products

The term product, as described herein, encompasses “polyphenol-dairy (e.g., milk) protein product,” “edible material-dairy (e.g., milk) protein product” and “polyphenol-protein product”.

A product as used herein refers to the co-precipitated components from a plant juice, a dairy (e.g., milk) product and/or a ground edible material. In various aspects, the co-precipitation is facilitated by reducing the pH of the composition. In further embodiments, and according to methods described herein, the product is obtained by combining a dairy (e.g., milk) product and a ground edible material. In some embodiments, the components are adsorbed to the dairy (e.g., milk) product and/or ground edible material.

In various embodiments, the product produced by the methods disclosed herein is formulated to accommodate specific combinations of component(s) obtainable from plant juice in order to produce or elicit specific physiological effects. For example, combinations of bioactive components of Ginkgo biloba and/or Goto kola are used for memory enhancement and can be added to a product described herein or ingested with a product described herein. In some embodiments, the product is useful to promote cardiovascular health, control fat and/or cholesterol, promote healthy joints, maintain or improve bone density, enhance cellular antioxidant capacity, control appetite, improve energy, increase endurance, promote weight loss, promote muscle enhancement, improve digestion, help prevent or treat colds, fight infection, or enhance memory. As will be apparent to one skilled in the art, many of the exemplary categories outlined above overlap and are not mutually exclusive. Thus, food products can be designed to contain a product that can bring about more than one desired physiological effect, or to comprise a plurality of products providing overlapping or distinct benefits.

The products described herein are also amenable to combination with other bioactive compounds to produce a food product. Thus, a product can be combined with certain combinations of therapeutic or diagnostic agents, or combinations of nutritional supplements.

“Therapeutic agent” as used herein means any compound useful for a therapeutic purpose, and a “diagnostic agent” is any compound useful for a diagnostic purpose. The terms as used herein are understood to mean any compound that is administered to a patient for the treatment, including amelioration of any symptom of a condition or disease, or diagnosis, of a condition that can be used in combination with any of the products herein disclosed.

It is contemplated that one or more therapeutic and/or diagnostic agents is administered in combination with a product of the disclosure, in one or repeated doses as can be determined by a clinician of skill in the art. Therapeutic agents useful in the materials and methods of the present disclosure can be determined by one of ordinary skill in the art.

In various embodiments, a composition is provided comprising an enriched product and a therapeutic agent. Therapeutic agents contemplated by the present disclosure include without limitation drug-like molecules, biomolecules and non-biomolecules.

Protein therapeutic agents include, without limitation peptides, enzymes, structural proteins, receptors and other cellular or circulating proteins as well as fragments and derivatives thereof, the aberrant expression of which gives rise to one or more disorders. Therapeutic agents also include, as one specific embodiment, chemotherapeutic agents. Therapeutic agents also include, in various embodiments, a radioactive material.

In various aspects, protein therapeutic agents include cytokines or hematopoietic factors including without limitation IL-1 alpha, IL-1 beta, IL-2, IL-3, IL-4, IL-5, IL-6, IL-11, colony stimulating factor-1 (CSF-1), M-CSF, SCF, GM-CSF, granulocyte colony stimulating factor (G-CSF), interferon-alpha (IFN-alpha), consensus interferon, IFN-beta, IFN-gamma, IL-7, IL-8, IL-9, IL-10, IL-12, IL-13, IL-14, IL-15, IL-16, IL-17, IL-18, erythropoietin (EPO), thrombopoietin (TPO), angiopoietins, for example Ang-1, Ang-2, Ang-4, Ang-Y, the human angiopoietin-like polypeptide, vascular endothelial growth factor (VEGF), angiogenin, bone morphogenic protein-1, bone morphogenic protein-2, bone morphogenic protein-3, bone morphogenic protein-4, bone morphogenic protein-5, bone morphogenic protein-6, bone morphogenic protein-7, bone morphogenic protein-8, bone morphogenic protein-9, bone morphogenic protein-10, bone morphogenic protein-11, bone morphogenic protein-12, bone morphogenic protein-13, bone morphogenic protein-14, bone morphogenic protein-15, bone morphogenic protein receptor IA, bone morphogenic protein receptor IB, brain derived neurotrophic factor, ciliary neutrophic factor, ciliary neutrophic factor receptor, cytokine-induced neutrophil chemotactic factor 1, cytokine-induced neutrophil, chemotactic factor 2α, cytokine-induced neutrophil chemotactic factor 2β, β endothelial cell growth factor, endothelin 1, epidermal growth factor, epithelial-derived neutrophil attractant, fibroblast growth factor 4, fibroblast growth factor 5, fibroblast growth factor 6, fibroblast growth factor 7, fibroblast growth factor 8, fibroblast growth factor 8b, fibroblast growth factor 8c, fibroblast growth factor 9, fibroblast growth factor 10, fibroblast growth factor acidic, fibroblast growth factor basic, glial cell line-derived neutrophic factor receptor α1, glial cell line-derived neutrophic factor receptor α2, growth related protein, growth related protein α, growth related protein β, growth related protein γ, heparin binding epidermal growth factor, hepatocyte growth factor, hepatocyte growth factor receptor, insulin-like growth factor I, insulin-like growth factor receptor, insulin-like growth factor II, insulin-like growth factor binding protein, keratinocyte growth factor, leukemia inhibitory factor, leukemia inhibitory factor receptor α, nerve growth factor nerve growth factor receptor, neurotrophin-3, neurotrophin-4, placenta growth factor, placenta growth factor 2, platelet-derived endothelial cell growth factor, platelet derived growth factor, platelet derived growth factor A chain, platelet derived growth factor AA, platelet derived growth factor AB, platelet derived growth factor B chain, platelet derived growth factor BB, platelet derived growth factor receptor α, platelet derived growth factor receptor β, pre-B cell growth stimulating factor, stem cell factor receptor, TNF, including TNF0, TNF1, TNF2, transforming growth factor α, transforming growth factor β, transforming growth factor β1, transforming growth factor β1.2, transforming growth factor β2, transforming growth factor β3, transforming growth factor β5, latent transforming growth factor β1, transforming growth factor β binding protein I, transforming growth factor β binding protein II, transforming growth factor β binding protein III, tumor necrosis factor receptor type I, tumor necrosis factor receptor type II, urokinase-type plasminogen activator receptor, vascular endothelial growth factor, and chimeric proteins and biologically or immunologically active fragments thereof. Examples of biologic agents include, but are not limited to, immuno-modulating proteins such as cytokines, monoclonal antibodies against tumor antigens, tumor suppressor genes, and cancer vaccines. Examples of interleukins that may be used in conjunction with the compositions and methods of the present invention include, but are not limited to, interleukin 2 (IL-2), and interleukin 4 (IL-4), interleukin 12 (IL-12). Other immuno-modulating agents other than cytokines include, but are not limited to Bacillus Calmette-Guerin, levamisole, and octreotide.

As described by the present disclosure, in some aspects therapeutic agents include small molecules. The term “small molecule,” as used herein, refers to a chemical compound, for instance a peptidometic that may optionally be derivatized, or any other low molecular weight organic compound, either natural or synthetic. Such small molecules may be a therapeutically deliverable substance or may be further derivatized to facilitate delivery.

By “low molecular weight” is meant compounds having a molecular weight of less than 1000 Daltons, typically between 300 and 700 Daltons. Low molecular weight compounds, in various aspects, are about 100, about 150, about 200, about 250, about 300, about 350, about 400, about 450, about 500, about 550, about 600, about 650, about 700, about 750, about 800, about 850, about 900, about 1000 or more Daltons.

The term “drug-like molecule” is well known to those skilled in the art, and includes the meaning of a compound that has characteristics that make it suitable for use in medicine, for example and without limitation as the active agent in a medicament. Thus, for example and without limitation, a drug-like molecule is a molecule that is synthesized by the techniques of organic chemistry, or by techniques of molecular biology or biochemistry, and is in some embodiments a small molecule as defined herein. A drug-like molecule, in various embodiments, additionally exhibits features of selective interaction with a particular protein or proteins and is bioavailable and/or able to penetrate cellular membranes.

In various embodiments, therapeutic agents described in U.S. Pat. No. 7,667,004 (incorporated by reference herein in its entirety) are contemplated for use in the compositions and methods disclosed herein and include, but are not limited to, alkylating agents, antibiotic agents, antimetabolic agents, hormonal agents, and biologic agents.

Examples of alkylating agents include, but are not limited to, bischloroethylamines (nitrogen mustards, e.g. chlorambucil, cyclophosphamide, ifosfamide, mechlorethamine, melphalan, uracil mustard), aziridines (e.g. thiotepa), alkyl alkone sulfonates (e.g. busulfan), nitrosoureas (e.g. carmustine, lomustine, streptozocin), nonclassic alkylating agents (altretamine, dacarbazine, and procarbazine), platinum compounds (e.g., carboplastin, cisplatin and platinum (IV) (Pt(IV))).

Examples of antibiotic agents include, but are not limited to, anthracyclines (e.g. doxorubicin, daunorubicin, epirubicin, idarubicin and anthracenedione), mitomycin C, bleomycin, dactinomycin, plicatomycin.

Examples of antimetabolic agents include, but are not limited to, fluorouracil (5-FU), floxuridine (5-FUdR), methotrexate, leucovorin, hydroxyurea, thioguanine (6-TG), mercaptopurine (6-MP), cytarabine, pentostatin, fludarabine phosphate, cladribine (2-CDA), asparaginase, imatinib mesylate (or GLEEVEC®), and gemcitabine.

Examples of hormonal agents include, but are not limited to, synthetic estrogens (e.g. diethylstibestrol), antiestrogens (e.g. tamoxifen, toremifene, fluoxymesterol and raloxifene), antiandrogens (bicalutamide, nilutamide, flutamide), aromatase inhibitors (e.g., aminoglutethimide, anastrozole and tetrazole), ketoconazole, goserelin acetate, leuprolide, megestrol acetate and mifepristone.

Examples of plant-derived agents include, but are not limited to, vinca alkaloids (e.g., vincristine, vinblastine, vindesine, vinzolidine and vinorelbine), podophyllotoxins (e.g., etoposide (VP-16) and teniposide (VM-26)), camptothecin compounds (e.g., 20(S) camptothecin, topotecan, rubitecan, and irinotecan), taxanes (e.g., paclitaxel and docetaxel).

Chemotherapeutic agents contemplated for use include, without limitation, alkylating agents including: nitrogen mustards, such as mechlor-ethamine, cyclophosphamide, ifosfamide, melphalan and chlorambucil; nitrosoureas, such as carmustine (BCNU), lomustine (CCNU), and semustine (methyl-CCNU); ethylenimines/methylmelamine such as thriethylenemelamine (TEM), triethylene, thiophosphoramide (thiotepa), hexamethylmelamine (HMM, altretamine); alkyl sulfonates such as busulfan; triazines such as dacarbazine (DTIC); antimetabolites including folic acid analogs such as methotrexate and trimetrexate, pyrimidine analogs such as 5-fluorouracil, fluorodeoxyuridine, gemcitabine, cytosine arabinoside (AraC, cytarabine), 5-azacytidine, 2,2′-difluorodeoxycytidine, purine analogs such as 6-mercaptopurine, 6-thioguanine, azathioprine, 2′-deoxycoformycin (pentostatin), erythrohydroxynonyladenine (EHNA), fludarabine phosphate, and 2-chlorodeoxyadenosine (cladribine, 2-CdA); natural products including antimitotic drugs such as paclitaxel, vinca alkaloids including vinblastine (VLB), vincristine, and vinorelbine, taxotere, estramustine, and estramustine phosphate; epipodophylotoxins such as etoposide and teniposide; antibiotics such as actimomycin D, daunomycin (rubidomycin), doxorubicin, mitoxantrone, idarubicin, bleomycins, plicamycin (mithramycin), mitomycinC, and actinomycin; enzymes such as L-asparaginase; biological response modifiers such as interferon-alpha, IL-2, G-CSF and GM-CSF; miscellaneous agents including platinum coordination complexes such as cisplatin, Pt(IV) and carboplatin, anthracenediones such as mitoxantrone, substituted urea such as hydroxyurea, methylhydrazine derivatives including N-methylhydrazine (MIH) and procarbazine, adrenocortical suppressants such as mitotane (o,p′-DDD) and aminoglutethimide; hormones and antagonists including adrenocorticosteroid antagonists such as prednisone and equivalents, dexamethasone and aminoglutethimide; progestin such as hydroxyprogesterone caproate, medroxyprogesterone acetate and megestrol acetate; estrogen such as diethylstilbestrol and ethinyl estradiol equivalents; antiestrogen such as tamoxifen; androgens including testosterone propionate and fluoxymesterone/equivalents; antiandrogens such as flutamide, gonadotropin-releasing hormone analogs and leuprolide; and non-steroidal antiandrogens such as flutamide.

The one or more components of the product are at levels sufficient to affect the desired function of the body when taken regularly. Such levels are known in the art or can readily be determined by a skilled technician. It is understood that the total daily intake may be based on administration of one unit of the product, or it may be based on administration of more than one unit of the product. The amount of the one or more components in the product will thus vary, depending on the unit size relative to the desired daily dose.

The product can be formulated in various unit sizes depending on the amount of component(s) to be incorporated therein and on requirements of the recipient animal or target consumer. In some embodiments, the product is formulated to have a unit size between about 2 grams and about 30 grams. In another embodiment, a unit of the product is between about 3 grams and about 20 grams. In another embodiment, a unit of the product is between about 3 grams and about 15 grams. In another embodiment, a unit of the product is between about 3 grams and about 10 grams. Where appropriate, the product can be provided in a multi-dose format that is pre-scored into unit doses.

One of ordinary skill in the art will appreciate that the amount of one or more components obtainable from plant juice contained in the product will be dependent on the type of components and the requirements of the target consumer. For example, the recommended dosage of a component, such as a vitamin, is generally less, on a weight-to-weight basis, than the recommended dosage of a macro-nutrient, such as calcium, or nutritional supplements such as creatine, protein or fiber, which are known to be required in higher amounts in order to provide a physiological effect.

In some embodiments, it will be beneficial to quantify the amount of a component extractable from plant juice contained in the product. Quantification can be determined by methods well known in the art including, but not limited to, high performance liquid chromatography (HPLC), HPLC-photodiode array detection (PDA), HPLC-mass spectrometry (MS) and the pH differential method.

In one embodiment, the total amount of component(s) constitute less than about 25% by weight of the product. In another embodiment, total amount of component(s) constitute between 0.01% and 20% by weight of the product. In another embodiment, the component(s) constitute between 0.01% and 15% by weight of the product. In another embodiment, the component(s) constitute between 0.01% and 10% by weight of the product.

In an alternative embodiment, the total amount of the component(s) constitutes between 5% and 50% by weight of the product. In another embodiment, the total amount of the component(s) constitutes between 7% and 50% by weight of the product. In a further embodiment, the total amount of the component(s) constitutes between 10% and 50% by weight of the product. In yet another embodiment, the total amount of component(s) constitute at least about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 49%, about 50% by weight or more of the product.

In some embodiments, the product or one or more of the components therein is tested for efficacy in vivo. Typically, when such testing is conducted, efficacy is assessed by physiological effect or bioavailability studies using standard techniques in the pharmaceutical art, such as peak plasma levels and pharmacokinetic analyses (see, for example, Enna, et al., Current Protocols in Pharmacology, J. Wiley & Sons, New York, N.Y.).

Bioavailability studies are usually conducted by administering to groups of subjects various doses of the product under study over a pre-determined period of time and comparing plasma levels of the component(s) in these groups at varying intervals with an appropriate control or controls. Appropriate controls include groups of subjects drinking unprocessed fruit juice. The subjects may or may not have fasted prior to administration of the doses of the product. Single dose or multiple dose studies may be conducted. The studies can also be used to monitor any side-effects of the dosing regimens of the product under investigation by compiling reports of any adverse effects encountered during the course of the study and comparing them to side-effects reported by the control group(s). Optionally, optimal dosing schedules can also be determined in this manner.

Studies to determine whether the combination of component(s) in a product bring about the desired effect in a subject can also be conducted in a manner similar to the bioavailability studies described above. Such studies are routine in the art and can be readily designed and conducted by a skilled technician. End effect measurements are dependent on the type of effect the product is intended to bring about. For example, for weight loss applications, the body weight and/or body fat percentage of individual subjects to whom varying doses of the product is being administered can be monitored over a period of time and compared to that of individuals in control groups, for example, placebo groups or groups drinking unprocessed plant juice alone.

In some embodiments, the component is a phenolic compound. Phenolic compounds are characterized by having at least one aromatic ring with one or more hydroxyl groups (Crozier, A, I. B. Jaganathb, M. N. Clifford. 2009. Dietary phenolics: chemistry, bioavailability and effects on health. Nat. Prod. Reports. 26: 1001-1043). Many phenolic compounds can be derivatized (e.g., esterified or glucosylated) and/or form dimers, oligomers or polymers. Basic skeletons of non-derivatized phenolics include, but are not limited to, phenolic acids, acetophenones, phenylacetic acids, hydroxycinnamic acids, coumarins, naphthoquinones, xanthones, stilbenes, and flavonoids. Flavonoids are the most numerous of the phenolics and have numerous health benefits. The main subclasses of dietary flavonoids are flavonols, flavones, flavan-3-ols, anthocyanidins, flavanones and isoflavones, dihydroflavonols, flavan-3,4-diols, coumarins, chalcones, dihydrochalcones and aurones. Polymerization of hydroxylated or esterified flavan-3-ols leads to the formation of proanthocyanidins also known as condensed or non-hydrolyzable tannins. Proanthocyanidins that consist exclusively of (epi)catechin units are called procyanidins, and are the most abundant type of proanthocyanidins in plants. The other class of tannins, hydrolyzable tannins, are derived from gallic acid.

The term “polyphenol” is often used to refer to plant phenolic compounds, which are characterized by the presence of more than one phenol unit or building block per molecule. Polyphenols are generally divided into hydrolyzable tannins and phenylpropanoids (derived from phenylalanine), such as lignin, flavonoids, and condensed tannins. Some polyphenols are not present in live plants but are formed during processing of foods and beverages, such as black tea fermentation, wine making, and coffee and cocoa production. Such polyphenols are often called “derived polyphenols.”

In some embodiments, the phenolic compound is a flavonoid compound. In one embodiment, the phenolic compound is a flavonol. Flavonols are a class of flavonoids that have the 3-hydroxyflavone backbone (IUPAC name: 3-hydroxy-2-phenylchromen-4-one) and are linked to a carbohydrate, i.e., sugar. Exemplary flavonols include, but are not limited to, quercetin, 3-hydroxyflavone, azaleatin, fisetin, galangin, gossypetin, kaempferide, kaempferol, isohamnetin, morin, myricetin, natsudaidain, pachypodol, rhamnazin and rhamnetin. In another embodiment, the flavonoid compound is a flavonol glycoside. Exemplary flavonol glycosides include, but are not limited to, astragalin, azalein, hyperoside, isoquercitin, kaempferitin, myricitrin, quercitrin, robinin, rutin, spiraeoside, xanthorhamnin, amuirensin, icariin and troserutin. Phenolic compounds obtainable from plant juice comprising a 3-hydroxyflavone backbone are specifically contemplated.

In other embodiments, the phenolic compound is a flavanol. Flavanols are a class of flavonoids that have the 2-phenyl-3,4-dihydro-2H-chromen-2-ol backbone. Exemplary flavanols include, but are not limited to, flavan-3-ols (e.g., catechins and catechin gallates). In some embodiments, the flavanol is a compound selected from the group consisting of fisetinidol, robinetinidol, epicatechin, mesquitol, epigallocatechin, epicatechin gallate and epigallocatechin gallate. Phenolic compounds obtainable from plant juice comprising a 2-phenyl-3,4-dihydro-2H-chromen-2-ol backbone are specifically contemplated.

In other embodiments, the phenolic compound is a flavanone. Exemplary flavanones include, but are not limited to, butin, eriodictyol, hesperetin, homoeriodictyol, isosakuranetin, naringenin, pinocembrin, sakuranetin, sakuranin, poriol, and sterubin. In one embodiment, the flavonoid compound is a glycoside of a flavanone. Exemplary flavanone glycosides include, but are not limited to, eriocitrin, hesperedin, liquiritin, naringin, narirutin, poncirin, nirurin and sakuranin.

In other embodiments, the phenolic compound is an anthocyanidin. Exemplary anthocyanidins include, but are not limited to aurantinidin, cyanidin, 6-hydroxycyanidin, delphinidin, europinidin, luteolinidin, fisetinidin, guibourtinidin, robinetinidin, pelargonidin, lamvidin, peonidin, petunidin, 5-desoxy-malvidin, capensinidin, diosmetinidin, gesneridin and rosinidin. In some embodiments, the flavonoid compound is an anthocyanin (i.e., a glycoside of an anthocyoanidin). Exemplary anthocyanins include, but are not limited to, antirrhinin (cyanidin 3-O-rutinoside), chrysanthenin (cyanidin 3-glucoside), myrtillin (delphinidin 3-O-glucoside, tulipanin (delphinidin 3-O-rutinoside)), violdelphin (delphinidin 3-rutinoside-7-O-(6-O-(4-(6-O-(4-hydroxybenzoyl)-beta-D-glucosyl)oxybenzoyl)-beta-D-glucoside), malvin (diglucoside of malvidin), oenin (malvidin 3-O-glucoside), primulin (malvidin-3-O-galactoside), pulchellidin 3-glucoside, pulchellidin 3-rhamnoside, cyanidin-3-(di-p-coumarylglucoside)-5-glucoside, commelinin (a tetranuclear (4 Mg²⁺) metal complex, in which two Mg²⁺ ions chelate to six anthocyanin molecules, while the other two Mg²⁺ ions bind to six flavone molecules), cyanosalvianin (a metalloanthocyanin: 3-O-(6-O-p-coumaroylglucopyranosyl)-5-O-(4-O-acetyl-6-O-malonylglucopyranosyl), delphinidin, 7,4′-di-O-glucopyranosylapigenin and magnesium ion) and protocyanin (supermolecular pigment consisting of a complex of anthocyanin, flavone, one ferric iron, one magnesium and two calcium ions).

In other embodiments, the phenolic compound is an isoflavonoid. Isoflavonoids have the 3-phenylchromen-4-one backbone. In one embodiment, the isoflavonoid is a phytoestrogen. Phenolic compounds obtainable from plant juice comprising a 3-phenylchromen-4-one backbone are specifically contemplated.

In other embodiments, the component is an alkaloid. In some embodiments, the alkaloid is caffeine. Caffeine is a naturally occurring xanthine alkaloid found in varying quantities in the seeds (e.g., beans), leaves, and fruit of some plants (e.g., where it acts as a natural pesticide). In humans, caffeine may have numerous beneficial effects. The most common use of caffeine as a supplement is as a central nervous system stimulant and performance enhancer, particularly in terms of mood, mental tasks and alertness (Smith et al., J Psychopharmacol. 19(6):620-6, 2005). Common sources of caffeine are coffee, tea, and, to a lesser extent, cocoa bean. Less commonly used sources of caffeine include the yerba maté and guarana plants, which are sometimes used in the preparation of teas and energy drinks. Two of caffeine's alternative names, mateine and guaranine, are derived from the names of the yerba maté and guarana plants.

One of the world's primary sources of caffeine is the coffee “bean” (which is the seed of the coffee plant), from which coffee is brewed. Caffeine content in coffee varies widely depending on the type of coffee bean and the method of preparation used; even beans within a given bush can show variations in concentration. In general, one serving of coffee ranges from 40 mg, for a single shot (30 ml) of arabica-variety espresso, to about 100 mg for a cup (120 ml) of drip coffee. In general, dark-roast coffee has less caffeine than lighter roasts because the roasting process reduces the bean's caffeine content. Arabica coffee normally contains less caffeine than the robusta variety.

Tea is another common source of caffeine. Tea is the agricultural product of the leaves, leaf buds, and internodes of Camellia sinensis (the “Tea plant”). Teas are prepared and cured by various methods. The aromatic beverage is typically prepared from the cured leaves by combination with hot or boiling water. There are at least six varieties of tea, i.e., white, yellow, green, oolong, black and pu-erh, of which the most commonly found on the market are white, green, oolong and black. Different tea varieties may be made from the same plant (i.e., Camellia sinensis), with the leaves being processed differently and, in the case of fine white tea, grown differently. Pu-erh tea, a post-fermented tea, is also often used medicinally.

The term “herbal tea” refers to an infusion or tisane of leaves, flowers, fruit, herbs or other plant material from a plant other than Camellia sinensis. Exemplary plants for herbal tea production are Chrysanthemum, ginger, honeysuckle, dandelion, and jasmine. The term “red tea” refers to an infusion made from either black tea or the South African rooibos plant (containing no Camellia sinensis).

In another embodiment, the component obtainable from plant juice is a terpenoid (or an isoprenoid). Terpenoids are derived from five-carbon isoprene units assembled and modified in many different ways. Classes of plant terpenoids, based on the number of isoprene units, include but are not limited to, hemiterpenoids, monoterpenoids, sesquiterpenoids, diterpenoids, sesterterpenoids, triterpenoids, tetraterpenoids and polyterpenoids. Exemplary terpenoids include artemisinin, carotenoids pigments, camphor, menthol, limonene, carvone, nepetalactone, hecogenin, digitoxigenin, chicory sesqueterpene lactones and triptolide.

In some embodiments, the component obtainable from plant juice is selected from the group consisting of antioxidants, carotenoids, caffeine, ecdysteroids, isothiocyanates, sesquiterpene lactones, barberine, gingerols, ginsenosides, glycycrrhizin, polymethoxylated flavones, tocotrienols, glucosinolates, punicalagins, soluble dietary fiber and organosulfur compounds from onions and garlic, as well as compounds or mixtures of compounds from Echinacea extracts, saw palmetto extracts, ginkgo extracts, black cohosh extracts, St. John's wort extracts, milk thistle extracts and vitamins (including vitamin A (retinol), vitamin B₁ (thiamine), vitamin C (ascorbic acid), vitamin D (calciferol), vitamin B₂ (riboflavin), vitamin E (tocopherol), vitamin B₁₂ (cyanocobalamin), vitamin K (phylloquinone), vitamin B₅ (pantothenic acid), vitamin B₇ (biotin), vitamin B₆ (pyridoxine), vitamin B₃ (niacin) and vitamin B₉ (folic acid)).

In some embodiments, the component obtainable from plant juice is selected from the group consisting of proteins, stiviol glucosides, proanthocyanidins, flavan-3-ols (vatechins and catechin gallates), hydrolyzable tannins (gallotannins and ellagitannins), phlorotannins, gingerols, sesquiterpene lactones, sulforaphane, isothiocyanates, anthocyanins, resveratrol, quercetin and caffeine. Anthocyanins are present in all tissues of higher plants, including leaves, stems, roots, flowers and fruits. Plants known in the art to be rich in anthocyanins are Vaccinium species, such as acai (320 mg/100 g), blueberry (558 mg/100 g), chokeberry (1480 mg/100 g), cranberry and bilberry, Rubus berries including black raspberry (589 mg/100 g), red raspberry (365 mg/100 g), blackberry (317 mg/100 g), blackcurrant (190-270 mg/100 g), redcurrant (80-420 mg/100 g), cherry (350-400 mg/100 g), eggplant (750 mg/100 g), black rice, Concord grape (888 mg/100 g) and muscadine grape, purple corn (1642 mg/100 g), red cabbage, black soybean (2,000 mg/100 g) and violet petals. Plant juice obtainable from plants rich in anthocyanins is specifically contemplated.

Resveratrol is found in the skin of red grapes and is a constituent of red wine. Plant juice obtainable from plants rich in resveratrol is specifically contemplated.

Foods known in the art to be rich in quercetin include capers, lovage, apples, tea plant (Camellia sinensis), onion (especially red onion), red grapes, citrus fruit, tomato, broccoli and other leafy green vegetables, and a number of berries including cherry, raspberry, bog whortleberry, lingonberry, cranberry, chokeberry, sweet rowan, rowanberry, sea buckthorn berry, crowberry, and the fruit of the prickly pear cactus. Plant juice obtainable from plants rich in quercetin is specifically contemplated.

Catechins are polyphenolic antioxidant plant metabolites. Catechins are abundant in teas derived from the tea plant Camelia sinensis (including white tea, green tea, black tea and Oolong tea) as well as in some cocoas and chocolates (made from the seeds of Theobroma cacao). Plant juice obtainable from plants rich in catechins is specifically contemplated.

Selection of appropriate product(s) for combination in a composition comprising a dairy (e.g., milk) product and/or ground edible material and/or a plant-derived polyphenol to form a co-precipitate for administration to a given animal is considered to be within the ordinary skill of a worker in the art and it is understood that products suitable for administration to humans may differ from those suitable for other animals. Furthermore, it will be apparent that inappropriate combinations of products, for example, those that counteract each other, are disfavored.

In another embodiment, the products from a plant juice, dairy (e.g., milk) product and/or ground edible material are proteins. Exemplary proteins include, but are not limited to, protease inhibitors (e.g., potato protease inhibitor I and potato protease inhibitor II), proteases (e.g., papain and bromelain) and dairy (e.g., milk) proteins (e.g., casein, whey, lactoglobulin and lactalbumin).

### Plant Juice

Plant material for producing the plant juice useful in the methods described herein is, in some embodiments, the juice of a blueberry, blackberry, raspberry, hockenberry, gooseberry, boysenberry, acai berry, baneberry, barberry, bearberry, bilberry, chokeberry, bunchberry, buffalo berry, chokecherry, cowberry, elderberry, cranberry, dew berry, currant, farkleberry, goji berry, gooseberry, grape, holly berry, huckleberry, ivy berry, june berry, juniper berry, lingonberry, logan berry, mistletoe berry, nannyberry, Oregon grape, persimmon, pokeberry, privet berry, salmonberry, strawberry, sugarberry, tayberry, thimbleberry, white mulberry, red mulberry, black mulberry, wineberry, wintergreen, yew berry, or young berry. In further embodiments, the plant juice is from a fruit-producing plant selected from the group consisting of plums, apricots, peaches, apples, oranges, lemons, limes, tangerines, grapefruit, bananas, pears, cherries, grapes, tomatoes, strawberries, cranberries, figs, pineapple, watermelon, pumpkin, cantaloupe, mango, papaya, peanuts, walnuts, pecans, almonds, cashew nuts, prunes, raisins, pineapple, cucumbers, coffee, noni and eggplant. In another embodiment, the plant material is obtainable from a vegetable plant selected from the group consisting of potatoes, onions, green onions, shallots, garlic, carrots, turnips, beets, parsnips, radishes, rutabaga, celery, mushrooms, corn, okra, spinach, cabbage, kale, lettuce, broccoli, cauliflower, string beans, soybeans, peas, cucumbers, squash, zucchini, lettuce, broccoli rabe, broccoli romanesco, rhubarb, collard greens, brussels sprout, bok choy, arugula and daikon. In yet other embodiments, the plant material is obtainable from a medicinal plant selected from the group consisting of St. John's wort, Echinacea, saw palmetto, ginkgo, ginseng, black cohosh, and dairy (e.g., milk) thistle. In still other embodiments, the plant material is obtainable from a fungus including but not limited to mushrooms, such as almond mushrooms, lingzhi mushrooms, caterpillar fungus, shiitake mushrooms, button mushrooms, Portobello mushrooms, straw mushrooms, oyster mushrooms, enokitake, milk mushrooms, morels, chanterelles, truffles, black trumpets and porcini mushrooms. In yet another embodiment, the plant material is obtainable from algae, such as blue green algae (e.g., Spirulina), green algae and red algae.

In rare circumstances, a plant juice as a whole may be harmful to at least one mammal and may, therefore, not be useful as a plant juice as defined herein. Such potentially non-useful plant juices may contain an edible material, however, and if so, the potentially non-useful plant juice is contemplated as suitable for the methods described herein.

Without wishing to be bound to any particular theory, it appears that the sorption of a component (for example and without limitation, a protein) from a plant juice is based on the ability of several types of phenolic compounds present in plants, such as cranberry phenolic compounds, to precipitate soluble proteins resulting in the formation of insoluble protein phenolic complexes. Again, without being bound to any particular theory, it appears that the phenolic compounds precipitate soluble proteins, at least in part, by crosslinking them into larger, less soluble complexes.

As described herein, a plant-derived polyphenol (present in, for example and without limitation, a plant juice) is combined with a dairy (e.g., milk) product and/or ground edible material by any means known in the art to form an admixture. The term “admixture” as used herein refers to a composition produced by mixing or commingling a plant juice with a dairy (e.g., milk) product and/or ground edible material. In one embodiment, the combining step comprises a method selected from the group consisting of mixing, contacting, and/or putting together the plant juice with the dairy (e.g., milk) product and/or ground edible material.

In another embodiment, the combining step further comprises straining the plant juice and dairy (e.g., milk) product and/or ground edible material mixture through a filter that retains the dairy (e.g., milk) product and/or ground edible material. It is recognized that bringing the dairy (e.g., milk) product and/or ground edible material into contact with one or more plant juices will result in some sorption of the dairy (e.g., milk) product and/or ground edible material, leading to partial or complete conversion of the dairy (e.g., milk) product and/or ground edible material to product, as those terms are defined and used herein.

### Ground Edible Material and Dairy (e.g., Milk) Product

In one aspect, the ground edible material is a plant flour. The use of other ground edible materials such as soybean protein concentrate, soybean protein isolate, protein powder (including, but not limited to, egg powder, gluten and yeast powder) and cellulose- or chitin-containing material (including, but not limited to, non-soluble vegetable fibers) is also contemplated. In other embodiments, the ground edible material is a bran, produced from the outer layer of plant seeds. Bran includes, but is not limited to, wheat bran, corn bran, rice bran oat bran and barley bran.

In one embodiment, the plant flour comprises at least 15 weight percent protein. In other embodiments, the flour comprises at least 20, at least 25, at least 30, at least 35, at least 40, at least 45, at least 50, at least 60, at least 65, at least 70 or more weight percent protein. In some embodiments, the plant flour is a leguminous flour. Some proteins in legume flour belong to the globulin family of seed storage proteins called leguminins (11S) and vicilins (7S), or, in the case of soybeans, glycinin and beta-conglycinin.

In specific exemplary embodiments, the plant flour is selected from the group consisting of soybean flour, wheat flour, almond flour, aramanth flour, brown rice flour, buckwheat flour, cassava flour, chestnut flour, chickpea flour, chuno flour, corn flour, cornstarch, glutinous rice flour, noodle flour, hazelnut flour, pea flour, bean flour, peanut flour, potato starch flour, rice flour, rye flour, tapioca flour, teff flour, arrowroot flour, taro flour, quinoa flour, mulga flour, ironweed flour, umbrella bush flour, tjuntjula flour, wakalpulka flour, witchetty bush flour, wiry wattle flour, Mitchell grass flour, nardoo flour, old man saltbush flour and wangunu flour.

In one embodiment, the ground edible material is selected from the group consisting of soybean flour, soybean protein concentrate and soybean protein isolate. Soybean flour contains trypsin inhibitors, hemagglutinins, and cysteine proteases. The insoluble carbohydrates in soybeans consist of complex polysaccharides, e.g., cellulose, hemicellulose, and pectin. The majority of soybean carbohydrates are considered dietary fiber. Soluble carbohydrates such as disaccharides are present in lower amounts and include sucrose, raffinose, and stachyose.

Three kinds of soybean flour are commercially available: Natural (or full-fat soybean flour), which contains all of the natural oils; low-fat soybean flour, which contains about one third of the natural oils; and defatted soybean flour, which has 99% of the oils removed during processing. Each type is usually heated or roasted at some stage(s) of preparation to improve palatability and flavor. Defatted soy flour is higher in protein content, close to 50 percent, and contains fewer calories per serving than natural soybean flour. The use of natural, low-fat and defatted soybean flour in the methods described herein is specifically contemplated. In addition, the use of other soy products such as soy protein concentrate (low-fat or defatted soybean flour without the soluble carbohydrates) and soy protein isolate (typically 90% soy protein by dry weight) are also contemplated.

Dairy (e.g., milk) products contemplated for use according to the disclosure include without limitation dry milk, evaporated milk, whole milk, low fat milk, 2% milk, 1% milk, heavy cream and a mixture thereof. In aspects in which the dairy (e.g., milk) product is a dry milk, it is contemplated that in some embodiments the milk product is solubilized with a plant juice to obtain the product.

It is also contemplated that the dairy (e.g., milk) is a solution comprising a dairy (e.g., milk) protein. In these aspects, the dairy (e.g., milk) protein is selected from the group consisting of casein, whey and a mixture thereof.

It is understood that milk can be obtained from a variety of milk-producing mammals, including but not limited to cow, goat, sheep, buffalo, yak, ox, pig, camel, and llama.

Other aspects of the disclosure are drawn to products formed from ground edible material and plant juice being brought into contact. In some embodiments, ground edible material and plant juice are combined at an exemplary ratio of 5 g to 100 g, mass of ground edible material to a volume of plant juice of 50 mL to 100 mL. In another embodiment, a ratio from 30 g to 100 g mass of ground edible material to a volume of 50 mL to 100 mL of plant juice is used. In yet another embodiment, a ratio of about 5 g, about 10 g, about 20 g, about 30 g, about 40 g, about 50 g, about 60 g, about 70 g, about 80 g, about 90 g, about 100 g, about 110 g, about 120 g, about 130 g, about 140 g, about 150 g, about 160 g, about 170 g, about 180 g about 190 g, about 200 g or more mass of the ground edible material to a volume of 50 mL to 100 mL of plant juice is contemplated. The amount of ground edible material and plant juice for use in the methods described herein can be readily increased to a commercial scale by one of ordinary skill in the art.

In some embodiments, plant juice and dairy (e.g., milk) product are combined at an exemplary ratio of about 1:3, volume of plant juice containing phenolic compound(s) to the volume of dairy (e.g., milk) product. In other embodiments, the ratio is 1:2, 1:4, 1:5 or more volume of plant juice containing phenolic compound(s) to the volume of dairy (e.g., milk) product. The amount of plant juice and dairy (e.g., milk) product for use in the methods described herein are readily increased to a commercial scale by one of ordinary skill in the art.

### Liquor

The liquor, in some embodiments, is further processed to concentrate the non-products after bringing the plant juice in contact with the dairy (e.g., milk) product and/or ground edible material and, in various aspects, reducing the pH as described herein. The non-products are, in some embodiments, used as natural sweeteners, food coloring or food dyes.

In various aspects, the non-products are processed or purified from the liquor through techniques known in the art, including but not limited to physical processes, fermentation, and enzymolysis. Appropriate processes and purification techniques include, but are not limited to, absorption, adsorption, agglomeration, centrifugation, chopping, cooking (baking, frying, boiling, roasting), cooling, cutting, chromatography, coating, crystallization, digestion, drying (spray, freeze drying, vacuum), evaporation, distillation, electrophoresis, emulsification, encapsulation, extraction, extrusion, filtration, fermentation, grinding, infusion, maceration, microbiological processing (rennet, enzymes), mixing, peeling, percolation, refrigeration/freezing, squeezing, steeping, washing, heating, mixing, ion exchange, lyophilization, osmosing, precipitation, salting out, sublimation, ultrasonic treatment, concentration, flocculation, homogenization, and reconstitution.

Use of the Product and Plant Liquor

In some embodiments, a product or liquor produced by the methods described herein are incorporated into consumer products. Consumer products are products available for purchase and/or use by individual consumers and include food products (including, but not limited to, enriched food products (see below), dietary supplements (see below), medical foods (see below), cosmetic products (see below) and other personal care products. In addition, the product may be formulated into a pharmaceutical product (see below).

Enriched Food Products

In some embodiments the product is incorporated into a food product to produce an enriched food product. The term “food product” as used herein refers to any substance containing nutrients that can be ingested by an organism to produce energy, promote health and wellness, stimulate growth, and/or maintain life. In one embodiment, the product produced by the methods described herein is used in the preparation of enriched food products comprising high amounts of concentrated component(s) obtainable from plant juice separated from non-products (e.g., carbohydrates, sugars, fats, and oils). The term “enriched food product” as used herein refers to a food product that has been modified to include the product described herein, which provides a benefit such as a health/wellness-promoting and/or disease-preventing/mitigating/treating property beyond the basic function of supplying nutrients. Such enriched food products deliver an effective dose of the component(s) obtainable from plant juice in a few servings. Drinking the original plant juices to obtain the equivalent amount of component(s) provided in the product may be impossible or impractical because of the large volumes that would have to be consumed, high amounts of associated calories, and undesirable health effects associated with ingesting high-calorie sugars, carbohydrates, and other structural chemicals.

Thus, a method of making an enriched food product comprising one or more concentrated component(s) obtainable from plant juice and/or a dairy (e.g., milk) product is also provided herein. Such a method comprises, in one aspect, combining the juice and/or dairy (e.g., milk) product with a ground edible material to form an admixture containing a product comprising the component(s); separating the product from the juice and/or dairy (e.g., milk) product, thereby concentrating the component(s) from the juice and/or dairy (e.g., milk) product in edible form; and incorporating the product into a food product, thereby making an enriched food product comprising the concentrated component(s) obtainable from plant juice and/or a dairy (e.g., milk) product. In various aspects, the method further comprises a reduction of the pH of the composition to increase the co-precipitation of the components of the plant juice and/or dairy (e.g., milk) product and the ground edible material.

The product can be incorporated into any food product. Exemplary food products include, but are not limited to, baked goods (cakes, cookies, crackers, breads, scones and muffins), dairy-type products (including but not limited to cheese, yogurt, custards, rice pudding, mousses, ice cream, frozen yogurt, frozen custard), desserts (including, but not limited to, sherbet, sorbet, water-ices, granitas and frozen fruit purees), spreads/margarines, pasta products and other cereal products, meal replacement products, nutrition bars, trail mix, granola, beverages (including, but not limited to, smoothies, water or dairy beverages and soy-based beverages), and breakfast-type cereal products such as oatmeal. For beverages, the product (or isolated non-products) may be in solution, suspended, emulsified or present as a solid.

In some embodiments, the enriched food product is a meal replacement product. The term “meal replacement product” as used herein refers to an enriched food product that is intended to be eaten in place of a normal meal. Nutrition bars and beverages that are intended to constitute a meal replacement are types of meal replacement products. The term also includes products which are eaten as part of a meal replacement weight loss or weight control plan, for example snack products which are not intended to replace a whole meal by themselves, but which may be used with other such products to replace a meal or which are otherwise intended to be used in the plan. These latter products typically have a calorie content in the range of from 50-200 kilocalories per serving.

In other embodiments, the food product is a dietary supplement. The term “dietary supplement” as used herein refers to a substance taken by mouth that contains a “dietary ingredient” intended to supplement the diet. The term “dietary ingredients” includes, but is not limited to, the component(s) as defined herein as well as vitamins, minerals, herbs or other botanicals, amino acids, and substances such as enzymes, organ tissues, glandulars, and metabolites.

In yet other embodiments, the food product is a medical food. The term “medical food” as used herein means a food which is formulated to be consumed or administered under the supervision of a physician and which is intended for the specific dietary management of a disease or condition for which distinctive nutritional requirements, based on recognized scientific principles, are established by medical evaluation.

In some embodiments, an enriched food product comprising the product or one or more component(s) thereof further comprises a bioavailability enhancer, which acts to increase the absorption of the component(s) by the body. Bioavailability enhancers can be natural or synthetic compounds. In one embodiment, the enriched food product comprising the product further comprises one or more bioavailability enhancers in order to enhance the bioavailability of the bioactive component(s).

Natural bioavailability enhancers include ginger, caraway extracts, pepper extracts and chitosan. The active compounds in ginger include 6-gingerol and 6-shogoal. Caraway oil can also be used as a bioavailability enhancer (U.S. Patent Application No. 2003/022838). Piperine is a compound derived from pepper (Piper nigrum or Piper longum) that acts as a bioavailability enhancer (see U.S. Pat. No. 5,744,161). Piperine is available commercially under the brand name Bioperine® (Sabinsa Corp., Piscataway, N.J.). In some embodiments, the natural bioavailability enhancer is present in an amount of from 0.02% to 0.6% by weight based on the total weight of enriched food product.

Examples of suitable synthetic bioavailability enhancers include, but are not limited to, Gelucire®, Labrafil® and Labrasol®, Lauroglycol®, Pleurol Oleique® (Gattefosse Corp., Paramus, N.J.) and Capmul® (Abitec Corp., Columbus, Ohio).

The properties of the enriched food products disclosed herein comprising the product ensure that the foods are easy to take and/or to administer. In some embodiments, the product or one or more component(s) thereof is formulated for administration to humans and thus contain flavors that would appeal to humans, such as fruit-based flavors. A product or one or more component(s) thereof that is formulated with confectionery-like qualities and flavors is also appealing to children who are often resistant to taking medications or supplements due to unpleasant tastes or texture. Thus, in other embodiments, the product or one or more component(s) thereof provides a means of easily providing products obtainable from plant juice to children.

### Food Additives

In some embodiments, the plant liquor and/or milk liquor (or non-products isolated therefrom) are incorporated within (or added to) a food product to improve the palatability, flavor or color of the food product.

In some embodiments, the plant and/or milk liquor is subsequently processed to concentrate the non-products from the plant and/or milk liquor to produce sweet-tasting food additives (e.g., natural sweeteners and syrups), flavorings and colorings. The concentration step, in some embodiments, comprises evaporation under vacuum with or without heat, boiling, sun- or heat-drying, freeze-drying, spray drying, reverse osmosis or other known methods of concentrating substances in liquids.

The term “natural sweetener” as used herein refers to any substance originating in nature that when added to a food or beverage sweetens the taste of the food or beverage.

The terms “food coloring” or “food dye” as used herein is any substance that when added to food or drink changes the color of the food or drink. Exemplary food colorings obtainable from the non-products include, but are not limited to, caramel coloring (obtained from caramelized sugar), annatto (a reddish-orange dye made from the seed of the achiote), chlorophyll (green dye typically made from chlorella algae), betanin (a red dye extracted from beets), turmeric (obtained from curcuminoids), paprika, saffron (obtained from carotenoids), pandan and butterfly pea.

To ensure reproducibility, the colored components of these substances are often provided in highly purified form, and for increased stability and convenience, the colored components are, in some embodiments, formulated in suitable carrier materials (solid and liquids).

### Cosmetic Applications

In some embodiments, the component(s) isolated from the product are useful as cosmeceuticals. The term “cosmeceutical” as used herein means an ingredient for a cosmetic, body care or hair care personal product having a positive effect on the physical condition of the body (e.g., skin, nails, hair). In some embodiments, products containing component(s) having antioxidant properties (e.g., anthocyanins and resveratrol) would be useful for cosmetic (or personal care) applications in which the inclusion of antioxidants is desired. For example and without limitation, in such embodiments, the product (or isolated component(s) from the product) is incorporated into a cosmetic composition for conditioning, moisturizing and smoothing human skin and preventing or reducing the appearance of lined, wrinkled or aged skin. In some embodiments, products containing other component(s) (including, but not limited to, quercetin, 3-hydroxyflavone, azaleatin, fisetin, galangin, gossypetin, kaempferide, kaempferol, isohamnetin, morin, myricetin, natsudaidain, pachypodol, rhamnazin, rhamnetin, astragalin, azalein, hyperoside, isoquercitin, kaempferitin, myricitrin, quercitrin, robinin, rutin, spiraeoside, xanthorhamnin, amuirensin, icariin, troserutin, fisetinidol, robinetinidol, epicatechin, mesquitol, epigallocatechin, epicatechin gallate, epigallocatechin gallate, butin, eriodictyol, hesperetin, homoeriodictyol, isosakuranetin, naringenin, pinocembrin, sakuranetin, sakuranin, poriol, sterubin, eriocitrin, hesperedin, liquiritin, naringin, narirutin, poncirin, nirurin, sakuranin, aurantinidin, cyanidin, 6-hydroxycyanidin, delphinidin, europinidin, luteolinidin, fisetinidin, guibourtinidin, robinetinidin, pelargonidin, lamvidin, peonidin, petunidin, 5-desoxy-malvidin, capensinidin, diosmetinidin, gesneridin, rosinidin, antirrhinin, chrysanthenin, myrtillin, tulipanin, violdelphin, malvin, oenin, primulin, pulchellidin 3-glucoside, pulchellidin 3-rhamnoside, cyanidin-3-(di-p-coumarylglucoside)-5-glucoside, commelinin, cyanosalvianin, protocyanin, protodelphion, phytoestrogen, caffeine, artemisinin, carotenoids pigments, camphor, menthol, limonene, carvone, nepetalactone, hecogenin, digitoxigenin, chicory sesqueterpene lactones, triptolide, caffeine, ecdysteroids, isothiocyanates, sesquiterpene lactones, barberine, gingerols, ginsenosides, glycycrrhizin, polymethoxylated flavones, tocotrienols, glucosinolates, punicalagins, soluble dietary fiber and organosulfur compounds from onions and garlic, as well as compounds or mixtures of compounds from Echinacea extracts, saw palmetto extracts, ginkgo extracts, black cohosh extracts, St. John's wort extracts, milk thistle extracts and vitamins (including vitamin A (retinol), vitamin B₁ (thiamine), vitamin C (ascorbic acid), vitamin D (calciferol), vitamin B₂ (riboflavin), vitamin E (tocopherol), vitamin B₁₂ (cyanocobalamin), vitamin K (phylloquinone), vitamin B₅ (pantothenic acid), vitamin B₇ (biotin), vitamin B₆ (pyridoxine), vitamin B₃ (niacin) and vitamin B₉ (folic acid)) are incorporated into a cosmetic product.

In some embodiments, natural oils present in the liquor (e.g., plant or milk liquor) can be used as a cosmeceutical. For example, natural oils, including but not limited to, almond oil, castor oil, grapeseed oil, jojoba oil, coconut oil, avocado oil, carrot oil, rice bran oil, rose hips oil, wheatgerm oil, passion flower oil, Brazil nut oil, watermelon seed oil, macadamia nut oil, starflower oil, Artemisia oil, St. John's Wort Oil (Hypericum perforatum), Marigold or Calendula Oil (Calendula officinalis) and meadowfoam seed oil would be useful in cosmetic applications wherein the conditioning and/or moisturizing of the skin is desired. In some embodiments, natural compounds (e.g., anthocyanins, turmeric) present in the plant or milk liquor or product can be used as natural pigments for cosmetics.

Compositions suitable for personal care products generally are formulated as, e.g., shampoos, conditioners, shower gels, liquid hand cleansers, facial cleansers, moisturizers, lotions, skin lotions and creams (such as eye creams and lip creams), facial skin cosmetics (such as blusher and highlighter), eye cosmetics (such as eye shadow, eye brow color, and eye liner), lip cosmetics (such as lip rouge), foundation, concealer, wrinkle-soothing sera, mascaras, skin facial masks, sunscreens, scalp hair-styling aids, facial hair-styling aids, emulsions, oils, mousses, ointments, milks, pomades, solutions, sprays, aerosols, powders, foams, gels (such as skin gels, eye gels, and lip gels), or other skin or hair products known in the art.

### Pharmaceutical Products

In some embodiments, the product or component(s) isolated from the product are incorporated into a pharmaceutical product or composition. Thus, compositions comprising the product or component(s) isolated from the product are also contemplated by the disclosure.

Pharmaceutical compositions comprise a prophylactically or therapeutically effective amount of the product or component(s) isolated from the product described herein, and typically one or more pharmaceutically acceptable carriers or excipients (which are discussed below).

### Routes of Administration and Dosage

The disclosure contemplates compositions comprising a product (or the product alone) or one or more component(s) thereof that are, in some embodiments, tabletted, encapsulated or otherwise formulated for oral administration. The compositions may be provided as pharmaceutical compositions, nutraceutical compositions (e.g., a dietary supplement), or as a food or beverage additive, as defined by the U.S. Food and Drug Administration. The dosage form for the above compositions are not particularly restricted. For example, liquid solutions, suspensions, emulsions, tablets, pills, capsules, sustained release formulations, powders, suppositories, liposomes, microparticles, microcapsules, sterile isotonic aqueous buffer solutions, and the like are all contemplated as suitable dosage forms.

In various embodiments, the compositions include one or more suitable diluents, fillers, salts, disintegrants, binders, lubricants, glidants, wetting agents, controlled release matrices, colorings, flavorings, carriers, excipients, buffers, stabilizers, solubilizers, commercial adjuvants, and/or other additives known in the art.

Any pharmaceutically acceptable (i.e., sterile and acceptably non-toxic as known in the art) liquid, semisolid, or solid diluent that serves as a pharmaceutical vehicle, excipient, or medium can be used. Exemplary diluents include, but are not limited to, polyoxyethylene sorbitan monolaurate, magnesium stearate, calcium phosphate, mineral oil, cocoa butter, and oil of theobroma, methyl- and propylhydroxybenzoate, talc, alginates, carbohydrates, especially mannitol, a-lactose, anhydrous lactose, cellulose, sucrose, dextrose, sorbitol, modified dextrans, gum acacia, and starch. Such compositions may influence the physical state, stability, rate of in vivo release, and rate of in vivo clearance of the functional compounds

Pharmaceutically acceptable fillers include, for example and without limitation, lactose, microcrystalline cellulose, dicalcium phosphate, tricalcium phosphate, calcium sulfate, dextrose, mannitol, and/or sucrose. Salts, including calcium triphosphate, magnesium carbonate, and sodium chloride, are used in various embodiments as fillers in the pharmaceutical compositions.

In some embodiments, binders are used to hold the composition containing the enriched substance together to form a hard tablet. Exemplary binders include materials from organic products such as acacia, tragacanth, starch and gelatin. Other suitable binders include, without limitation, methyl cellulose (MC), ethyl cellulose (EC) and carboxymethyl cellulose (CMC).

The amount and administration regimen of the product or one or more component(s) thereof is based on various factors relevant to the purpose of administration, for example human or animal age, sex, body weight, hormone levels, or other nutritional need of the human or animal. In some embodiments, the product is administered to an animal in an amount from 0.001 mg/kg body weight to 10 g/kg body weight. In some embodiments, the product or one or more component(s) thereof is administered to an animal in an amount of about 0.005 mg/kg, about 0.01 mg/kg, about 0.05 mg/kg, about 0.1 mg/kg, about 1 mg/kg, about 10 mg/kg, about 100 mg/kg, about 250 mg/kg, about 500 mg/kg, about 1 g/kg, about 2.5 g/kg, about 5 g/kg, about 7.5 g/kg, or about 10 g/kg body weight.

A typical regimen may comprise multiple doses of a product or one or more component(s) thereof. In one embodiment, the product or one or more component(s) thereof is administered once per day. The product or one or more component(s) thereof may be administered to an individual at any time. In some embodiments, the product or one or more component(s) thereof is administered concurrently, prior to, or at the consumption of a meal.

It will be appreciated that the product or one or more component(s) thereof is useful in the fields of human medicine and veterinary medicine to provide concentrated component(s) obtainable from a plant juice or a dairy (e.g., milk) product to a subject in need thereof. Thus, the subject or individual to be treated may be a mammal, such as a human. For veterinary purposes, subjects include, for example, farm animals such as cows, sheep, pigs, horses, and goats; companion animals such as dogs and cats; exotic and/or zoo animals; laboratory animals including mice, rats, rabbits, guinea pigs, and hamsters; and poultry such as chickens, turkeys, ducks, and geese.

In some embodiments, the product or one or more component(s) thereof is formulated for administration to a non-human animal. Administration of component(s) obtainable from plant juice to an animal in conventional solid dosage forms, such as tablets and capsules, can be problematic in that the animal often expels them, and multiple dosing is often difficult because the animal learns to resist the dosing procedure. It will be readily apparent that the product or one or more component(s) thereof, formulated as an enriched food product, is ideally suited for administration of component(s) obtainable from plant juice to animals. When formulated for this purpose, the enriched food product comprising the product or one or more component(s) thereof may contain flavors that more typically appeal to non-human animals, for example, fish or meat flavors.

### EXAMPLES

### Example 1

### Comparison of Different Dairy (e.g., Milk) Products for their Effectiveness in Co-Precipitating Anthocyanins from Blueberry Juice

Different types of dairy (e.g., milk) products were tested to determine which, if any, could co-precipitate and concentrate compounds known for their health/nutritional value (e.g. anthocyanins). Dry Milk (Acme Co.), Casein Protein (Gold Standard), Whey Protein (GNC), and blueberry juice (R. W. Knudsen) were all purchased from a local grocery store. Each dairy (e.g., milk) product was added to three dilutions of blueberry juice concentrate (BBJC) 3×, 5× and 10× at a concentration of 133 g/L in a volume of 30 ml of the blueberry juice and mixed at room temperature for five minutes by inversion. pH measurements were taken before and after the addition of the dairy (e.g., milk) product. The final solution was adjusted to a pH of 4 by addition of 6 N Hydrochloric Acid (HCl), inducing precipitation of dairy (e.g., milk) proteins. The mixture was then centrifuged for 25 minutes at 2,000 rpm (Beckman, JA-17 rotor) and the decanted supernatant was subsequently filtered through a 0.22 μm syringe filter to further remove any particulate material that could interfere with the anthocyanin quantification step. The concentration of total monomeric anthocyanins in untreated and dairy (e.g., milk) product-treated blueberry juice was determined using the AOAC pH differential method (Reference: J. AOAC Int. 88, 1269(2005)) adapted for 96-well plate format and results were expressed as cyanidin-3-glucoside equivalents. The difference in anthocyanin concentration between untreated and dairy (e.g., milk) product-treated juice samples was used to estimate the concentration of anthocyanins bound to the precipitated dairy (e.g., milk) product.

Anthocyanins comprise about 30% of total blueberry polyphenols and all polyphenols were found to bind to dairy (e.g., milk) protein matrix proportionally to their concentration in juice. For the convenience of data collection anthocyanin binding was measured as a marker for all blueberry polyphenols.

All tested dairy (e.g., milk) product complexes sorb total polyphenols as effectively as the products sorb anthocyanins. The total polyphenol content in the final dairy (e.g., milk) product matrix was approximately 3 times that of anthocyanins. Results further indicated that, while the amount of precipitated product varied among dairy (e.g., milk) products, addition of blueberry juice increased the total amount of polyphenol enriched dairy (e.g., milk) protein matrix precipitated from solution compared to dairy (e.g., milk) product recovered in the absence of blueberry juice. The largest relative increase in the matrix yield was observed with whey protein, which is normally rather soluble and does not precipitate well in low pH.

This Example illustrates the utility of the reduction in pH in facilitating the co-precipatation of dairy (e.g., milk) proteins with plant-derived components.

### Example 2

### Co-Precipitation of Total Dry Dairy (e.g., Milk) Proteins with Blueberry Juice Polyphenols

Dry milk powder at a concentration of 133 g/L was added to 30 mL blueberry juice concentrate (BBJC) diluted 3×, 5× and 10×. As described above, the pH was recorded before and after the addition of dry milk powder and the final solution was adjusted to a pH of 4 inducing the precipitation of milk proteins.

Results indicate that as the concentration of blueberry juice increases (from 10× diluted concentrate to 3× diluted concentrate) the concentration of anthocyanins (ACN) and polyphenols that are co-precipitated with milk proteins increases. At the highest concentration of blueberry juice tested (3× diluted concentrate) anthocyanin content of the resulting precipitated matrix was 6.8 mg/g (see Table 1, below).

| | | | | ACN | |
|---|---|---|---|---|---|
| | Dry | pH of | Matrix | content, | ACN |
| | Skim | liquid, | yield, | mg/g added | content, |
| | Milk | before/ | mg/ml | dry skim | mg/g final |
| Sample | mg/ml* | after milk | solution | milk | matrix |
| Dry Skim | 133 | 7.1/6.6 | 62 | 0 | 0 |
| Milk (DM) | | | | | |
| DM + 3x BBJC | 133 | 3.2/4.0 | 92 | 4.7 | 6.8 |
| DM + 5x BBJC | 133 | 3.3/4.5 | 112 | 3.7 | 4.4 |
| DM + 10x | 133 | 3.6/5.1 | 112 | 2.1 | 2.5 |
| BBJC | | | | | |

Accordingly, the methods of the disclosure are useful when using a dry milk product in conjunction with a plant juice such as blueberry juice. The Example also illustrates that the yield of co-precipitated anthocyanins is directly proportional to the concentration of blueberry juice added.

### Example 3

### Co-Precipitation of Whey Proteins with Blueberry Juice Polyphenols

Whey protein powder at a concentration of 133 g/L was added to 30 mL blueberry juice concentrate diluted 3×, 5× and 10×. As described above, the pH was recorded before and after the addition of dry milk powder and the final solution was adjusted to a pH 4 inducing the precipitation of milk proteins.

Results show that as the blueberry juice concentration increases, the amount of precipitated blueberry polyphenols-whey protein product also increases as well as the amount of anthocyanins bound to the product as compared to the initial amount of whey proteins. The highest concentration of bound anthocyanins (11.56 mg/g) in the precipitated matrix was achieved at a 5× diluted blueberry juice. Data also show that at pH 4, blueberry polyphenols can render a large portion of whey protein insoluble by co-precipitating with it. Normally, whey protein is rather soluble and does not precipitate well at low pH. Blueberry juice polyphenols were able to co-precipitate much greater amounts of whey protein than can be precipitated by pH 4 alone (compare 20.7 mg/ml to 70.7 mg/ml) (see Table 2, below).

TABLE 2

| | | | | ACN | |
|---|---|---|---|---|---|
| | | pH of | Matrix | content, | ACN |
| | | liquid, | yield, | mg/g | content, |
| | Whey | before/ | mg/ml | added | mg/g final |
| Sample | mg/ml | after whey | solution | whey | matrix |
| Whey Protein | 133 | 7.4/6.2 | 20.7 | 0 | 0 |
| Powder (W) | | | | | |
| W + 3x BBJC | 133 | 3.2/4.1 | 70.7 | 4.01 | 7.57 |
| W + 5x BBJC | 133 | 3.3/4.3 | 31 | 2.69 | 11.56 |
| W + 10x BBJC | 133 | 3.6/4.7 | 33 | 1.28 | 5.12 |

The foregoing data establish that the methods of the disclosure are useful when using whey protein in conjunction with a plant juice such as blueberry juice. The Example also illustrates that the yield of precipitated whey protein is increased more than three-fold with the addition of plant juice polyphenols versus the yield of precipitated whey protein with a reduction in pH alone.

### Example 4

### Co-Precipitation of Casein Proteins with Blueberry Juice Polyphenols

Casein protein powder at a concentration of 133 g/L was added to 30 mL blueberry juice concentrate diluted 3×, 5× and 10×. As described in Example 1, the pH was recorded before and after the addition of dry milk powder and the final solution was adjusted to a pH 4 causing the precipitation of casein protein and blueberry polyphenols-casein.

Results show that as the blueberry juice concentration increases, the amount of precipitated blueberry polyphenols-casein protein product also increases. The highest concentration of bound anthocyanins (3.8 mg/g) was achieved at a 5× and 10× diluted blueberry juice (see Table 3, below).

TABLE 3

| | | | | ACN | ACN |
|---|---|---|---|---|---|
| | | | Matrix | content, | content, |
| | | pH of liquid, | yield | mg/g | mg/g |
| | Casein | before/after | mg/ml | added dry | final |
| Sample | mg/ml | casein | solution | casein | matrix |
| Casein Protein | 133 | 7.4/6.4 | 98 | 0 | 0 |
| Powder (C) | | | | | |
| C + 3x BBJC | 133 | 3.2/4.2 | 223 | 4.1 | 2.4 |
| C + 5x BBJC | 133 | 3.3/4.6 | 161 | 4.6 | 3.8 |
| C + 10x BBJC | 133 | 3.6/5.3 | 90 | 2.6 | 3.8 |

This Example illustrates that the methods of the disclosure are useful when using dry casein protein powder in conjunction with a plant juice such as blueberry juice. Coupled with the data in Example 2, the results show a range of products can be used in dry form in the methods according to the disclosure.

1. A method of obtaining a polyphenol-milk protein product comprising the steps of:
(a) combining a composition comprising a plant-derived polyphenol and a milk product comprising a milk protein to form the polyphenol-milk protein product and a liquor; and
(b) separating the polyphenol-milk protein product from the liquor.

2. The method of claim 1 further comprising the step of reducing the pH.

3. The method of claim 2 wherein the pH is reduced by addition of an acid selected from the group consisting of acetic acid, adipic acid, citric acid, fumaric acid, glucono-delta-lactone, hydrochloric acid, lactic acid, malic acid, phosphoric acid, succinic acid and tartaric acid.

4. The method of claim 2 wherein the pH is reduced by adding to the composition a substance selected from the group consisting of lactic acid bacteria and yeast.

5. The method of claim 2, wherein the pH is reduced to about 4.0.

6. The method of claim 1 further comprising the step of adding rennet.

7. The method of claim 1, wherein the composition is a dry composition.

8. The method of claim 1, wherein the milk is selected from the group consisting of dry milk, evaporated milk, whole milk, low fat milk, 2% milk, 1% milk, heavy cream and a mixture thereof.

9. The method of claim 1, wherein the milk is a solution comprising a milk protein.

10. The method of claim 9 wherein the milk protein is selected from the group consisting of casein, whey and a mixture thereof.

11. The method of claim 1, wherein a plant juice supplies the plant-derived polyphenol.

12. The method of claim 11, wherein the plant juice is the juice of a blueberry, blackberry, raspberry, hockenberry, gooseberry, boysenberry, acai berry, baneberry, barberry, bearberry, bilberry, chokeberry, bunchberry, buffalo berry, chokecherry, cowberry, elderberry, cranberry, dew berry, currant, farkleberry, goji berry, gooseberry, grape, holly berry, huckleberry, ivy berry, june berry, juniper berry, lingonberry, logan berry, mistletoe berry, nannyberry, Oregon grape, persimmon, pokeberry, privet berry, salmonberry, strawberry, sugarberry, tayberry, thimbleberry, white mulberry, red mulberry, black mulberry, wineberry, wintergreen, yew berry, or young berry.

13. The method of claim 11, wherein the plant juice is selected from the group consisting of blueberry juice and cranberry juice.

14. The method of claim 1, further comprising a ground edible material.

15. The method of claim 14 wherein the ground edible material is a plant flour.

16. The method of claim 1, wherein the separating is performed by a process selected from the group consisting of filtration, centrifugation and natural density separation.

17. A method of obtaining an edible material-milk protein product comprising the steps of:
(a) combining a composition comprising a ground edible material and milk to form the edible material-milk protein product and a liquor; and
(b) separating the edible material-milk protein product from the liquor.

18. The method of claim 17, further comprising the step of reducing the pH.

19-27. (canceled)

28. A method of obtaining a polyphenol-protein product comprising the steps of:
(a) combining a composition comprising a plant-derived polyphenol and a ground edible material to form the polyphenol-protein product and a liquor; and
(b) separating the polyphenol-protein product from the liquor.

29-35. (canceled)

36. A composition comprising the product of claim 1.

37. A composition comprising the product of claim 17.

38. A composition comprising the product of claim 28.
